(19) United States
(12) Patent Application Publication
(10) Pub. No.: US 2026/0366878 A1
(43) Pub. Date: Nov. 19, 2026

(54) AUTOMATIC ANNOTATION OF ROAD LAYOUT MAPS

(71) Applicant: Five AI Limited, Cambridge (GB)

(72) Inventor: Jared Khan, Cambridge (GB)

(73) Assignee: Five AI Limited, Cambridge (GB)

(21) Appl. No.: 19/487,012

(22) PCT Filed: May 30, 2024
(86) PCT No.: PCT/EP2024/064949

§ 371 Date: Nov. 24, 2025

(30) Foreign Application Priority Data
Jun. 1, 2023 (GB) 2308214.2

(51) Int. Cl. G01C 21/32; G01C 21/00

(52) U.S. Cl. CPC G01C 21/32; G01C 21/3815; G01C 21/387

(57) ABSTRACT

The present disclosure provides methods and systems for automatically annotating a second map using annotation data from a first map. A source piece of road structure associated with a first piece of annotation data is identified in the first map, the source piece of road structure is matched with a target piece of road structure in the second map, and a second piece of annotation data for annotating the target piece of road structure in the second map is generated using the first piece of annotation data.

### TECHNICAL FIELD

The present disclosure pertains to support tools for autonomous vehicles. Such tools have offline applications to support the development and testing of autonomous vehicle systems (including simulation-based testing), as well as online applications within an autonomous vehicle system to facilitate real-time planning, prediction and/or other online functions.

### BACKGROUND

There have been major and rapid developments in the field of autonomous vehicles. An autonomous vehicle (AV) is a vehicle which is equipped with sensors and control systems which enable it to operate without a human controlling its behaviour. An autonomous vehicle is equipped with sensors which enable it to perceive its physical environment, such sensors including for example cameras, radar and lidar. Autonomous vehicles are equipped with suitably programmed computers which are capable of processing data received from the sensors and making safe and predictable decisions based on the context which has been perceived by the sensors.

An autonomous vehicle may be fully autonomous (in that it is designed to operate with no human supervision or intervention, at least in certain circumstances) or semi-autonomous. Semi-autonomous systems require varying levels of human oversight and intervention. An Advanced Driver Assist System (ADAS) and certain levels of Autonomous Driving System (ADS) may be classed as semi-autonomous. A “level 5” vehicle is one that can operate entirely autonomously in any circumstances, because it is always guaranteed to meet some minimum level of safety. Such a vehicle would not require manual controls (steering wheel, pedals etc.) at all. By contrast, level 3 and level 4 vehicles can operate fully autonomously but only within certain defined circumstances (e.g. within geofenced areas). A level 3 vehicle must be equipped to autonomously handle any situation that requires an immediate response (such as emergency braking); however, a change in circumstances may trigger a “transition demand”, requiring a driver to take control of the vehicle within some limited timeframe. A level 4 vehicle has similar limitations; however, in the event the driver does not respond within the required timeframe, a level 4 vehicle must also be capable of autonomously implementing a “minimum risk maneuver” (MRM), i.e. some appropriate action(s) to bring the vehicle to safe conditions (e.g. slowing down and parking the vehicle). A level 2 vehicle requires the driver to be ready to intervene at any time, and it is the responsibility of the driver to intervene if the autonomous systems fail to respond properly at any time. With level 2 automation, it is the responsibility of the driver to determine when their intervention is required; for level 3 and level 4, this responsibility shifts to the vehicle's autonomous systems and it is the vehicle that must alert the driver when intervention is required.

The ability to precisely capture and describe driving scenarios is a cornerstone of autonomous vehicle technology. A typical driving scenario includes a static road layout and various dynamic agents (other vehicles, pedestrians, cyclists, animals etc.) that an autonomous vehicle (the ego vehicle) is required to navigate. An ego vehicle may be required to predict the motion of other agents and plan safely within a complex road network. In an online context, prediction and planning components require a scenario description that is sufficiently detailed and precise. In an offline context, a scenario description may be required as an input to a simulator to facilitate simulation-based testing of an autonomous vehicle stack prior to deployment on a real-world vehicle.

‘High definition’ maps (with centimetre precision or greater) are often used in autonomous driving in contexts such as testing and motion planning. HD maps typically capture geometries of individual lanes within a road network (such as lane boundary geometries and lane markings) as well as topological driving relationships between lanes (e.g. driveable and non-driveable links between lanes). Typically, a road network will be divided into higher-level ‘topological’ components in a hierarchical manner, such as roads (with individual road identifiers and links between road), lanes (containing low-level lane geometries) and sections within a road, junctions (containing intersecting roads) and junction groups. Global coordinates (e.g. (x,y) cartesian coordinates) of every piece of road/geometry are contained in the map though, for efficiency, certain lane geometries may be encoded in ‘road’, e.g. (longitudinal ‘s’, lateral ‘t’) coordinates relative to a road reference line, which may itself be encoded in (x,y) coordinates. In this case, any (s,t) coordinates can be translated to corresponding (x,y) coordinates based on the road reference line. Maps may additionally encode a third height/elevation dimension in a similar manner.

For example, ASAM OpenDRIVE® schema for describing static road networks to the level of precision and accuracy required in autonomous driving contexts. The stated purpose of OpenDRIVE “is to provide a road network description that can be fed into simulations to develop and validate ADAS and AD [Autonomous Driving] features” [1]. OpenDRIVE is an XML-based schema that allows road networks to be described in a hierarchical fashion. Roads are described by road elements (<road>), connectable via link elements (<link>) within the road elements. Junction elements (<junction>) are required when linking more than two roads. Every road element is characterized by a single road reference line constructed from parameterized geometric elements. OpenDRIVE denotes longitudinal and latitudinal coordinates with respect to the reference line as “s” and “t” (reference line coordinates). Lanes are described by lane elements (<lane>) within a road element. Every road element must contain a center lane element of width zero and at least one “side-lane” element of non-zero width. The center lane serves as a reference for lane numbering. By default, the center lane lies along the road reference line, but can be offset from it. For conciseness, “side-lanes” may be referred to herein simply as lanes where the meaning is unambiguous. Side-lanes may have a fixed or variable width. A side-lane may have a width of zero along a given stretch of road, but zero-width side lanes for long distances should be avoided. Road elements may be divided into sections (lane sections) to accommodate roads with changing numbers of lanes, where each lane section has a fixed number of lanes. Roads and junctions are assigned string identifiers that should be unique within a road network. Lanes are identified via incremental lane numbering relative to the center lane, and the lane numbers are only unique within a lane section. Individual lanes within two linked roads may be linked via additional link elements within the lane elements. Road/lane geometries are described in terms of functions, where the functions can change along the road (for example, a road reference line might be described as a straight line function on a given interval, followed by a spiral function, and then an arc function; a lane might be described in terms of a width function that is constant on some interval, and then changes to a linearly increasing function etc.). Lanes may be drivable or non-drivable lanes.

In open drive, not all side-lanes are drivable. Rather “side-lane” is a broad concept to describe any road geometry. Examples of non-drivable side lines include restricted areas, pavements/sidewalks, hedgerows etc. Each side lane has configurable attributes which, among other things, indicate whether or not it is drivable.

### SUMMARY

It is common to encounter more than one map that represents the same road network, or more than one map in which some overlap in road networks may be found therebetween. Maps may be updated from time to time to improve their accuracy or precision, or to capture changes in a road network. Often, changes of this nature are relatively incremental, or may only affect relatively small part(s) of the road network. However, even small changes and/or changes to only small parts of the map can materially alter the way in which the same road network is described in different maps. In some cases, inconsistencies may arise between maps because there are multiple ways of describing the same road structure that are all equally valid with a particular map schema. In other cases, a modification may be required to the higher-level structure of a map in order to accommodate a relatively small change to the road geometry to comply with the map schema (e.g. adding or adjusting a label might require a new or modified lane section within a road). As a result, it is possible to encode two maps of the same road network with similar (or even identical) road/lane geometries but significant differences in their topological structure.

A problem addressed herein is one of transferring ‘annotations’ between maps of the same road network. In general, an annotation simply means some piece of data associated with a piece of road structure in a first map that is not present in (or otherwise associated with) a second map of the same road network. The annotation data may be contained in the map itself, or it may be separate from the map. It will be appreciated that when an updated map is provided, annotations associated with an earlier version of the map may not be provided in the updated map. An automated process for transferring annotations provides several benefits, such as removing human error in manually transferring the annotations, and reducing manual effort of reconfiguring annotations in a new map each time an updated version is provided. However, as discussed below, there are many technical challenges that must be overcome to provide the benefits of such an automated process.

A naïve approach would be to simply ‘place’ the annotation from the first map in the second map based on its global coordinates without modification. However, this is not suitable for all types of annotations, as certain annotations may be tied to the road structure. For example, a ‘yield signal’ may be defined as a point at which a vehicle travelling on a particular route through a road network should come to a stop. Different routes in a road network may be defined by distinct sequences of road structure elements, and a yield signal may apply only to one route. However, there may exist some spatial overlap between road structure elements of the different routes at a coordinate of the yield signal. The naïve approach above, being naïve to such overlapping road elements of different routes, may associate a yield signal annotation with a road element that lies on a route in which the signal need not be applied. Therefore, there is a need for a system that is capable of disambiguating overlapping road structure elements to identify a correct element with which to associate an annotation. For example, there is a need to be able to transfer an annotation, which is associated with a specific road ID at a specific [s,t] coordinate on a source map, to another (target) map, and assigning it an appropriate road ID and [s,t] coordinate in the target map, whilst keeping the global coordinate of the annotation precisely the same. Whilst this may appear straightforward, identifying the correct road element that forms part of a correct sequence of road elements in which the annotation applies is, in fact, challenging in certain situations. For example, a yield point may be placed on a road in the first map that belongs to a junction with various intersecting roads. In a second map, the road boundaries may have shifted and/or additional roads may have been added (e.g. to capture more fine-grained road structure, or new structures that have been recently built), meaning there is now significant ambiguity in the correct placement of the yield point on the second map. Moreover, any topological structure in the maps is often of limited value in this context for the reasons discussed above (for instance, a yield point in the first map might be explicitly or implicitly associated with a particular <road> element in the first map; however, there is no easy way to equate this with a second <road> element in the second road map because they will not necessary have the same road identifiers, and the higher level topology (roads, sections etc.) may be very different). The annotation transfer method described herein is useful, for example, because road IDs need not be stable between map versions (i.e., between the source and target maps), and because roads in the source map may be divided into multiple roads, for example because a new motorway entrance has been added and there is a need to split the motorway at the entrance point.

Yield points are merely one example of an annotation, and similar considerations apply to other forms of annotation having a geometry (e.g. location, orientation, shape etc.) that might need to be modified in some way in order to property transfer the annotation from a first map to a second map to account for differences in the road layout geometry (e.g. road geometry or lane geometry) in the second map relative to the first map. More generally, yield signals, also referred to as yield points, may be understood as an example of ‘agent control data’, which may be encoded as an annotation in a map to influence or prompt behaviour of a non-ego agent.

An annotation transfer tool is provided that is capable of automatically transferring annotations between maps. The tool is robust in the sense that it is able to resolve ambiguity in the context of annotation transfer, and thus annotate a second map with greater overall accuracy based on annotation transfer from a first map.

A first aspect of the present disclosure is directed to a computer-implemented method of automatically annotating a second road layout map using first annotation data for annotating a first road layout map, the method comprising: identifying in the first road layout map a source piece of road structure associated with a first piece of annotation data; matching the source piece of road structure with a target piece of road structure exhibited in the second road layout map; and generating, using the first piece of annotation data, a second piece of annotation data for annotating the target piece of road structure exhibited in the second road layout map.

In some embodiments, the step of matching the source piece of road structure with the target piece of road structure comprises: identifying a source sequence comprising multiple pieces road structure in the first road layout map including the source piece of road structure; identifying two or more candidate pieces of road structure in the second road layout map based on identifying a region of spatial overlap between each candidate piece of road structure and the source piece of road structure; for each candidate piece of road structure, identifying a corresponding candidate sequence comprising multiple pieces of road structure including that candidate piece of road structure; and identifying a matching candidate sequence by comparing the source sequence with the corresponding candidate sequence for each candidate piece of road structure, the target piece of road structure selected as the candidate piece of road structure belonging to the matching candidate sequence.

In some embodiments, the source sequence extends from the source piece of road structure at an initial sequence position, and for each candidate piece of road structure, the corresponding candidate sequence extends from the candidate piece of road structure at an initial sequence position; wherein the matching candidate sequence is identified by iteratively comparing the corresponding candidate sequence with the source sequence for each candidate piece of road structure by: calculating an intersection between the pieces of road structure at, respectively, the initial sequence position of a first of those sequences and the next sequence position of a second of those sequences, and if a non-zero intersection is calculated, repeatedly incrementing the sequence position of the second sequence whilst maintaining the sequence position of the first sequence and calculating an intersection between those sequence positions until a zero intersection is calculated or a final sequence position of the second sequence is reached, and if a zero intersection is calculated, decrementing the sequence position of the second sequence and repeatedly incrementing the sequence position of the first sequence, and calculating an intersection between those sequence positions until a zero intersection is calculated or a final sequence position of the first sequence is reached, wherein a candidate sequence is determined to match the source sequence responsive to calculating a non-zero intersection at a final sequence position of either of those sequences, the target piece of road structure selected as the candidate piece of road structure belonging to the matching candidate sequence.

In some embodiments, if: a zero intersection is calculated for a sequence position of the first sequence and a sequence position of the second sequence, the sequence position of the second sequence is decremented, the sequence position of the first sequence is incremented, and non-zero intersection is calculated, the method further comprises: repeatedly incrementing the sequence position of the second sequence whilst maintaining the sequence position of the first sequence and calculating an intersection between those sequence positions until a zero intersection is calculated or a final sequence position of the second sequence is reached.

In some embodiments, the iterative comparison terminates for each candidate piece of road structure: responsive to reaching a final position of either sequence and calculating a non-zero intersection for the final sequence position, resulting in a sequence match, or responsive to calculating a zero intersection between all three of: a sequence position of the first sequence and a sequence position of the second sequence, a previous sequence position of the first sequence and a next sequence position of the second sequence, and that sequence position of the first sequence and a next sequence position of the second sequence, resulting in a sequence mismatch.

In some embodiments, selecting the target piece of road structure comprises, if the source sequence is determined to match multiple candidate road sequences: calculating an intersection over union ratio between the source sequence and each matching candidate sequence, and selecting, as the target piece of road structure, the candidate piece of road structure belonging to the matching candidate sequence for which a greatest intersection over union ratio is calculated.

In some embodiments, each sequence embodies a single traversable path, each piece of road structure in that sequence being a portion of that traversable path.

In some embodiments, the first piece of annotation data comprises: a first identifier that identifies the source piece of road structure in the first road layout map; and a first coordinate of the annotation within the source piece of road structure; and wherein the second piece of annotation data comprises: a second identifier of the target piece of road structure in the second road layout map; and a second coordinate of the annotation within the target piece of road structure, the second coordinate determined based on the target piece of road structure.

In some embodiments, the first coordinate comprises a longitudinal or lateral coordinate within the first road layout map, and wherein the second coordinate comprises a longitudinal or lateral coordinate within the second road layout map.

In some embodiments, the first and second pieces of annotation data comprise agent control data configured to control the behaviour of an agent in a simulated environment.

In some embodiments, the method comprises testing a robotic planner by generating a simulated environment based on the second road layout map, in which an ego agent is controlled by the robotic planner under testing, and another dynamic agent responds to the agent control data.

A second aspect of the present disclosure is directed to a computer system comprising one or more computers programmed or otherwise configured to implement a method according to any of the above-described embodiments.

In some embodiments of the computer system, the one or more computers programmed or otherwise configured to implement a simulator configured to run a test scenario on the second road layout map, the test scenario comprising an ego agent controlled by a robotic planner under testing and at least one other dynamic agent navigating the second road layout map.

A third aspect of the present disclosure relates to a computer program product configured to program a computer system so as to carry out a method according to any of the above-described embodiments.

### BRIEF DESCRIPTION OF FIGURES

For a better understanding of the present disclosure, and to show how embodiments of the same may be carried into effect, reference is made by way of example only to the following figures in which:

FIG. 1A shows a schematic function block diagram of an autonomous vehicle stack;

FIG. 1B shows a schematic overview of an autonomous vehicle testing paradigm;

FIG. 1C shows a schematic block diagram of a scenario extraction pipeline;

FIG. 2 shows a schematic block diagram of a testing pipeline;

FIG. 3A shows a schematic block diagram of a visualization component for rendering a graphical user interface on which test results are displayed;

FIG. 3B shows a view available within a graphical user interface;

FIG. 4 shows a schematic block diagram of a scenario access system;

FIG. 4A shows an example a set of spatial indexes supporting a scenario query engine;

FIG. 5 shows an example road network;

FIG. 6 shows part of a road network annotated with OpenDRIVE elements used to describe the road network;

FIG. 7 shows an in-memory lane graph extracted from a static road layout;

FIG. 8 shows a first version of an exemplary first static layer comprising a road network of road structure elements that form a plurality of junctions;

FIG. 8a shows six instances of the static layer section of FIG. 8, each instance highlighting a driving route that may be taken in the road network;

FIG. 9 shows a second version of the same exemplary static layer as in FIG. 8;

FIG. 9a shows six instances of the static layer section of FIG. 9, each instance highlighting a driving route that may be taken in the road network;

FIG. 10a shows a source map comprising an annotation.

FIG. 10b shows a target map that represents a same driving scene as in FIG. 10a, but does not comprise the annotation.

FIG. 11 shows a flowchart that illustrates an exemplary annotation transfer method.

FIG. 12 shows a flowchart that illustrates an ‘step-along’ method for disambiguating candidate target road elements.

FIG. 13 shows an exemplary application of the step along method according to FIG. 12.

FIG. 14 shows a second exemplary application of the step along method according to FIG. 12.

It will be appreciated that where reference numerals of the form xxx-a, xxx-b etc., are used to denote a particular instance of a feature of a drawing, the same reference numeral without a specified letter suffix (e.g., a, b, etc.) may denote a generic instance of the same feature.

### DETAILED DESCRIPTION

Before the novel importation features of the static layer annotation tool (SLAT) are described, the following description introduces methods for encoding a static layer of a road network, and for querying a static layer to identify features therein.

A scenario query engine (SQE) is now described, which allows efficient geometric and topological querying of a static road layout. The static road layout may for example be formulated in OpenDRIVE or some other schema. Both geometric and topological queries return results in a form that can be interpreted in the context of the original road layout description. OpenDRIVE is intended to be mainly optimized for processing “on the wire”. To a degree, the schema seeks to avoid duplication of information (although this is by no means a hard-and-fast rule). All-in-all, the construction of the OpenDRIVE schema is not well-suited to certain forms of querying, rendering certain applications of OpenDRIVE seemingly impractical. The SQE addresses these issues as described below, which opens up new practical applications of OpenDRIVE and similar schemas.

The described techniques have both “online” and “offline” applications in autonomous driving.

An online (or “runtime”) application refers to an implementation within an autonomous vehicle stack to support autonomous planning or other decision-making functions (such as motion planning, motion prediction, route planning etc.). In an online context, a planner is required to plan driving actions for a given scenario, responding to changes in the scenario in real-time.

An offline application refers to other forms of applications, for example as part of a set of tools to support the development, testing and/or training of AV systems. By way of example, a testing pipeline is described below for assessing driving performance in real or simulated scenarios. Performance can include different facets of safety, comfort or progress towards some defined goal.

Whether real or simulated, a scenario requires an ego agent to navigate a real or modelled physical context. The ego agent is a real or simulated mobile robot that moves under the control of the stack under testing. The physical context includes static and/or dynamic element(s) that the stack under testing is required to respond to effectively. For example, the mobile robot may be a fully or semi-autonomous vehicle under the control of the stack (the ego vehicle). The physical context may comprise a static road layout and a given set of environmental conditions (e.g. weather, time of day, lighting conditions, humidity, pollution/particulate level etc.) that could be maintained or varied as the scenario progresses. A dynamic scenario additionally includes one or more other agents (“external” agent(s), e.g. other vehicles, pedestrians, cyclists, animals etc.).

In an offline simulation context, a scenario description is provided to an offline simulator as input, in order to expose a stack under testing to a simulated scenario. In an online context, a perception system may be used to generate a scenario description that can be used as a basis for higher-level functions, such as motion prediction and planning, which might involve some form of online simulation to simulate possible futures and plan accordingly.

A scenario description may be encoded using a scenario description language (SDL), or in any other form that can be consumed by whichever component(s) require it. As briefly discussed, the ASAM OpenDRIVE® standard defines a storage format for the static description of road networks and ASAM OpenSCENARIO® may be used to add dynamic content. OpenSCENARIO® defines a file format for the description of dynamic driving scenario content. OpenSCENARIO may be used in conjunction with OpenDRIVE. Other forms of scenario description may be used, including bespoke languages and formats, and the present techniques are not limited to any particular SDL, storage format, schema or standard.

A “scenario run” or “scenario instance” refers to a concrete occurrence of an agent(s) navigating a physical context, optionally in the presence of one or more other agents. A single scenario description can give rise to multiple simulated runs, with different outcomes, not least because those outcomes depend on decisions taken by the stack under testing. The terms “run” and “instance” are used interchangeably in this context.

### Example AV Stack

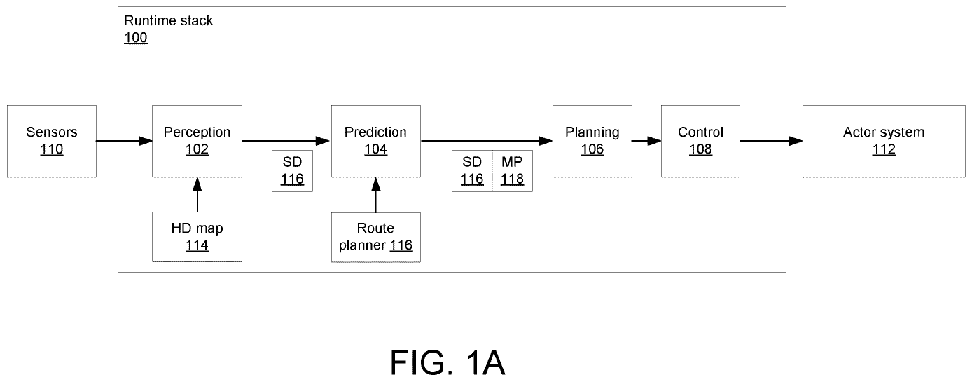

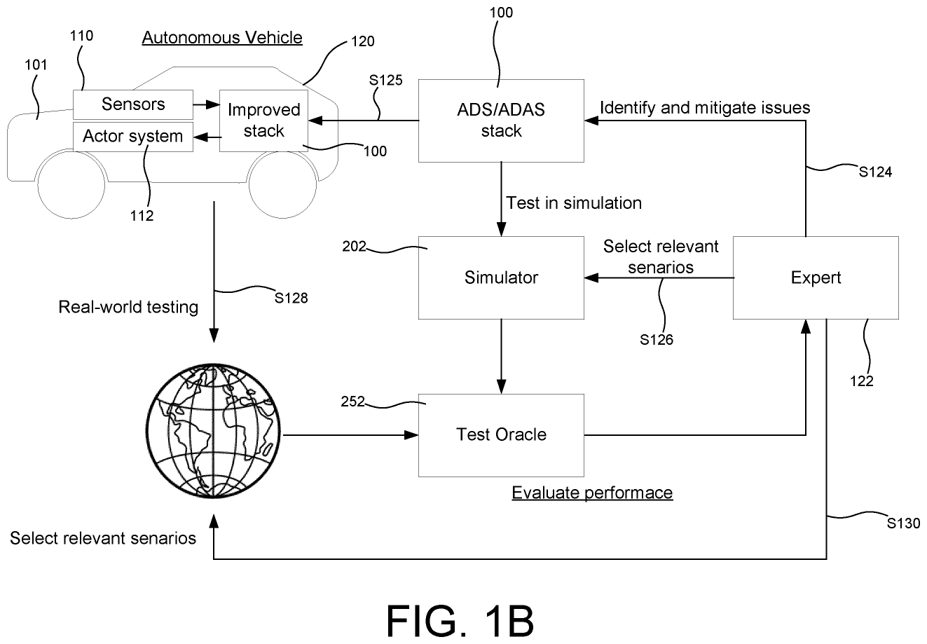

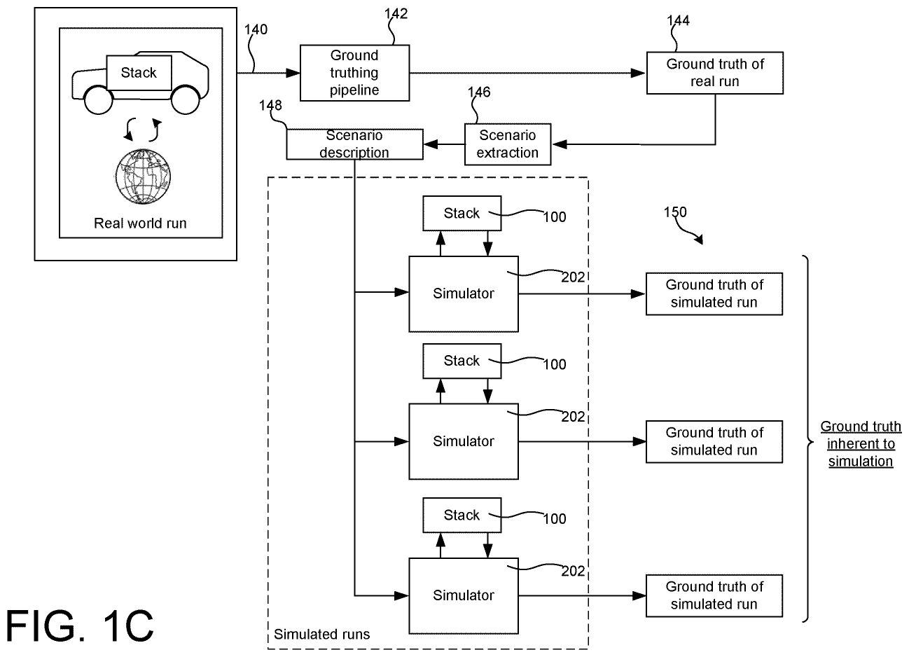

FIG. 1A shows a highly schematic block diagram of an AV runtime stack 100. The stack 100 may be fully or semi-autonomous. For example, the stack 100 may operate as an Autonomous Driving System (ADS) or Advanced Driver Assist System (ADAS).

The run time stack 100 is shown to comprise a perception (sub-) system 102, a prediction (sub-) system 104, a planning (sub-) system (planner) 106 and a control (sub-) system (controller) 108.

In a real-world context, the perception system 102 receives sensor outputs from an on-board sensor system 110 of the AV, and uses those sensor outputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc.

The perception system 102 typically comprises multiple perception components which co-operate to interpret the sensor outputs and thereby provide perception outputs to the prediction system 104.

In a simulation context, depending on the nature of the testing—and depending, in particular, on where the stack 100 is “sliced” for the purpose of testing (see below)—it may or may not be necessary to model the on-board sensor system 100. With higher-level slicing, simulated sensor data is not required therefore complex sensor modelling is not required.

The perception outputs from the perception system 102 are used by the prediction system 104 to predict future behaviour of external actors (agents), such as other vehicles in the vicinity of the AV.

Predictions computed by the prediction system 104 are provided to the planner 106, which uses the predictions to make autonomous driving decisions to be executed by the AV in a given driving scenario. The inputs received by the planner 106 would typically indicate a drivable area and would also capture predicted movements of any external agents (obstacles, from the AV's perspective) within the drivable area. The driveable area can be determined using perception outputs from the perception system 102 in combination with map information, such as an HD (high definition) map.

A core function of the planner 106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner 116, also referred to as a goal generator 116.

The controller 108 executes the decisions taken by the planner 106 by providing suitable control signals to an on-board actor system 112 of the AV. In particular, the planner 106 plans trajectories for the AV and the controller 108 generates control signals to implement the planned trajectories. Typically, the planner 106 will plan into the future, such that a planned trajectory may only be partially implemented at the control level before a new trajectory is planned by the planner 106. The actor system 112 includes “primary” vehicle systems, such as braking, acceleration and steering systems, as well as secondary systems (e.g. signalling, wipers, headlights etc.).

The example of FIG. 1A considers a relatively “modular” architecture, with separable perception, prediction, planning and control systems 102-108. The sub-stack themselves may also be modular, e.g. with separable planning modules within the planning system 106. For example, the planning system 106 may comprise multiple trajectory planning modules that can be applied in different physical contexts (e.g. simple lane driving vs. complex junctions or roundabouts). This is relevant to simulation testing for the reasons noted above, as it allows components (such as the planning system 106 or individual planning modules thereof) to be tested individually or in different combinations. For the avoidance of doubt, with modular stack architectures, the term stack can refer not only to the full stack but to any individual sub-system or module thereof.

The extent to which the various stack functions are integrated or separable can vary significantly between different stack implementations—in some stacks, certain aspects may be so tightly coupled as to be indistinguishable. For example, in other stacks, planning and control may be integrated (e.g. such stacks could plan in terms of control signals directly), whereas other stacks (such as that depicted in FIG. 1A) may be architected in a way that draws a clear distinction between the two (e.g. with planning in terms of trajectories, and with separate control optimizations to determine how best to execute a planned trajectory at the control signal level). Similarly, in some stacks, prediction and planning may be more tightly coupled. At the extreme, in so-called “end-to-end” driving, perception, prediction, planning and control may be essentially inseparable. Unless otherwise indicated, the perception, prediction planning and control terminology used herein does not imply any particular coupling or modularity of those aspects.

A “full” stack typically involves everything from processing and interpretation of low-level sensor data (perception), feeding into primary higher-level functions such as prediction and planning, as well as control logic to generate suitable control signals to implement planning-level decisions (e.g. to control braking, steering, acceleration etc.). For autonomous vehicles, level 3 stacks include some logic to implement transition demands and level 4 stacks additionally include some logic for implementing minimum risk maneuvers. The stack may also implement secondary control functions e.g. of signalling, headlights, windscreen wipers etc.

The term “stack” can also refer to individual sub-systems (sub-stacks) of the full stack, such as perception, prediction, planning or control stacks 104, 106, 108, which may be tested individually or in any desired combination. A stack can refer purely to software, i.e. one or more computer programs that can be executed on one or more general-purpose computer processors. It will be appreciated that the term “stack” encompasses software, but can also encompass hardware. In simulation, software of the stack may be tested on a “generic” off-board computer system, before it is eventually uploaded to an on-board computer system of a physical vehicle. However, in “hardware-in-the-loop” testing, the testing may extend to underlying hardware of the vehicle itself. For example, the stack software may be run on the on-board computer system (or a replica thereof) that is coupled to the simulator for the purpose of testing. In this context, the stack under testing extends to the underlying computer hardware of the vehicle. As another example, certain functions of the stack 110 (e.g. perception functions) may be implemented in dedicated hardware. In a simulation context, hardware-in-the loop testing could involve feeding synthetic sensor data to dedicated hardware perception components.

Within the stack 100, a scenario description 116 may be used as a basis for planning and prediction. The scenario description 116 is generated using the perception system 102, together with a high-definition (HD) map 114. By localizing the ego vehicle 114 on the map, it is possible to combine the information extracted in the perception system 104 (including dynamic agent information) with the pre-existing environmental information contained in the HD map 114. The scenario description 116 is, in turn, used as a basis for motion prediction in the prediction system 104, and the resulting motion predictions 118 are used in combination with the scenario description 116 as a basis for planning in the planning system 106.

### Example Testing Paradigm

FIG. 1B shows a highly schematic overview of a testing paradigm for autonomous vehicles. An ADS/ADAS stack 100, e.g. of the kind depicted in FIG. 1A, is subject to repeated testing and evaluation in simulation, by running multiple scenario instances in a simulator 202, and evaluating the performance of the stack 100 (and/or individual subs-stacks thereof) in a test oracle 252. The output of the test oracle 252 is informative to an expert 122 (team or individual), allowing them to identify issues in the stack 100 and modify the stack 100 to mitigate those issues (S124). The results also assist the expert 122 in selecting further scenarios for testing (S126), and the process continues, repeatedly modifying, testing and evaluating the performance of the stack 100 in simulation. The improved stack 100 is eventually incorporated (S125) in a real-world AV 101, equipped with a sensor system 110 and an actor system 112. The improved stack 100 typically includes program instructions (software) executed in one or more computer processors of an on-board computer system of the vehicle 101 (not shown). The software of the improved stack is uploaded to the AV 101 at step S125. Step S125 may also involve modifications to the underlying vehicle hardware. On board the AV 101, the improved stack 100 receives sensor data from the sensor system 110 and outputs control signals to the actor system 112. Real-world testing (S128) can be used in combination with simulation-based testing. For example, having reached an acceptable level of performance through the process of simulation testing and stack refinement, appropriate real-world scenarios may be selected (S130), and the performance of the AV 101 in those real scenarios may be captured and similarly evaluated in the test oracle 252.

Scenarios can be obtained for the purpose of simulation in various ways, including manual encoding. The system is also capable of extracting scenarios for the purpose of simulation from real-world runs, allowing real-world situations and variations thereof to be re-created in the simulator 202.

FIG. 1C shows a highly schematic block diagram of a scenario extraction pipeline. Data 140 of a real-world run is passed to a ‘ground-truthing’ pipeline 142 for the purpose of generating scenario ground truth. The run data 140 could comprise, for example, sensor data and/or perception outputs captured/generated on board one or more vehicles (which could be autonomous, human-driven or a combination thereof), and/or data captured from other sources such external sensors (CCTV etc.). The run data is processed within the ground truthing pipeline 142, in order to generate appropriate ground truth 144 (“trace(s)” and contextual data) for the real-world run. The ground-truthing process could be based on manual annotation of the ‘raw’ run data 140, or the process could be entirely automated (e.g. using offline perception method(s)), or a combination of manual and automated ground truthing could be used. For example, 3D bounding boxes may be placed around vehicles and/or other agents captured in the run data 140, in order to determine spatial and motion states of their traces. A scenario extraction component 146 receives the scenario ground truth 144, and processes the scenario ground truth 144 to extract a scenario description 148 that can be used for the purpose of simulation. The scenario description 148 is consumed by the simulator 202, allowing multiple simulated runs to be derived therefrom. Ground truth 150 is provided for each simulated run.

A “trace” is a history of an agent's location and motion over the course of a scenario. There are many ways a trace can be represented. Trace data will typically include spatial and motion data of an agent within the environment. The term is used in relation to both real scenarios (with real-world traces) and simulated scenarios (with simulated traces).

The term “perception” generally refers to techniques for perceiving structure in the real-world data 140, such as 2D or 3D bounding box detection, location detection, pose detection, motion detection etc. For example, a trace may be extracted as a time-series of bounding boxes or other spatial states in 3D space or 2D space (e.g. in a birds-eye-view frame of reference), with associated motion information (e.g. speed, acceleration, jerk etc.). In the context of image processing, such techniques are often classed as “computer vision”, but the term perception encompasses a broader range of sensor modalities.

### Testing Pipeline

Further details of an example testing pipeline incorporating the test oracle 252 will now be described. The examples that follow focus on simulation-based testing. However, as noted, the test oracle 252 can equally be applied to evaluate stack performance on real scenarios, and the relevant description below applies equally to real scenarios. The following description refers to the stack 100 of FIG. 1A by way of example. However, as noted, the testing pipeline 200 is highly flexible and can be applied to any stack or sub-stack operating at any level of autonomy.

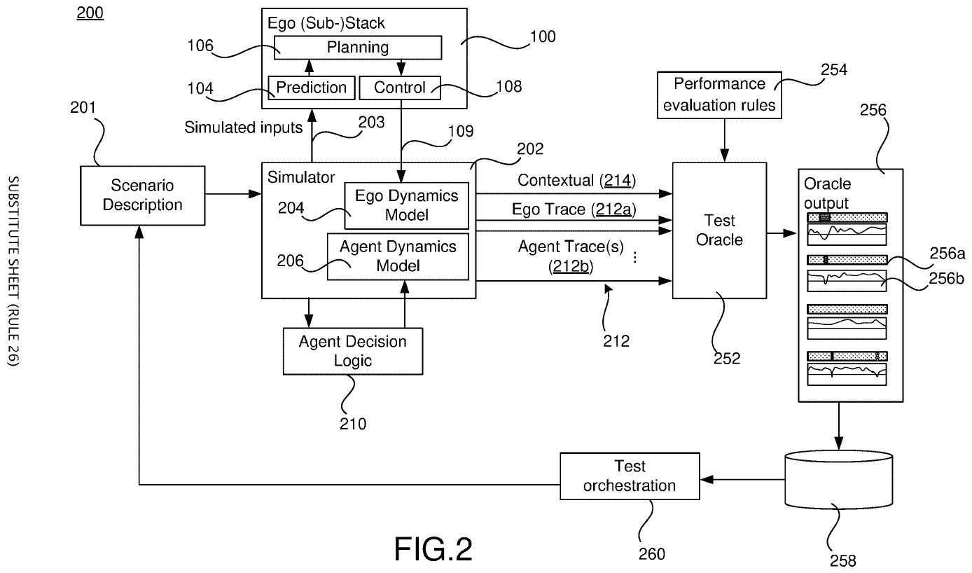

FIG. 2 shows a schematic block diagram of the testing pipeline, denoted by reference numeral 200. The testing pipeline 200 is shown to comprise the simulator 202 and the test oracle 252. The simulator 202 runs simulated scenarios for the purpose of testing all or part of an AV run time stack 100, and the test oracle 252 evaluates the performance of the stack (or sub-stack) on the simulated scenarios. As discussed, it may be that only a sub-stack of the run-time stack is tested, but for simplicity, the following description refers to the (full) AV stack 100 throughout. However, the description applies equally to a sub-stack in place of the full stack 100. The term “slicing” is used herein to the selection of a set or subset of stack components for testing.

The idea of simulation-based testing is to run a simulated driving scenario that an ego agent must navigate under the control of the stack 100 being tested. Typically, the scenario includes a static drivable area (e.g. a particular static road layout) that the ego agent is required to navigate, typically in the presence of one or more other dynamic agents (such as other vehicles, bicycles, pedestrians etc.). To this end, simulated inputs 203 are provided from the simulator 202 to the stack 100 under testing.

The slicing of the stack dictates the form of the simulated inputs 203. By way of example, FIG. 2 shows the prediction, planning and control systems 104, 106 and 108 within the AV stack 100 being tested. To test the full AV stack of FIG. 1A, the perception system 102 could also be applied during testing. In this case, the simulated inputs 203 would comprise synthetic sensor data that is generated using appropriate sensor model(s) and processed within the perception system 102 in the same way as real sensor data. This requires the generation of sufficiently realistic synthetic sensor inputs (such as photorealistic image data and/or equally realistic simulated lidar/radar data etc.). The resulting outputs of the perception system 102 would, in turn, feed into the higher-level prediction and planning systems 104, 106.

By contrast, so-called “planning-level” simulation would essentially bypass the perception system 102. The simulator 202 would instead provide simpler, higher-level inputs 203 directly to the prediction system 104. In some contexts, it may even be appropriate to bypass the prediction system 104 as well, in order to test the planner 106 on predictions obtained directly from the simulated scenario (i.e. “perfect” predictions).

Between these extremes, there is scope for many different levels of input slicing, e.g. testing only a subset of the perception system 102, such as “later” (higher-level) perception components, e.g. components such as filters or fusion components which operate on the outputs from lower-level perception components (such as object detectors, bounding box detectors, motion detectors etc.).

As an alternative to synthetic sensor data, all or part of the perception system 102 may be modelled, e.g. using one or more perception error models to introduce realistic error into the simulated inputs 203. For example, Perception Statistical Performance Models (PSPMs) or, synonymously, “PRISMs” may be used. Further details of the principles of PSPMs, and suitable techniques for building and training such models, may be bound in International Patent Publication Nos. WO2021037763 WO2021037760, WO2021037765, WO2021037761, and WO2021037766, each of which is incorporated herein by reference in its entirety.

Whatever form they take, the simulated inputs 203 are used (directly or indirectly) as a basis for decision-making by the planner 108. The controller 108, in turn, implements the planner's decisions by outputting control signals 109. In a real-world context, these control signals would drive the physical actor system 112 of AV. In simulation, an ego vehicle dynamics model 204 is used to translate the resulting control signals 109 into realistic motion of the ego agent within the simulation, thereby simulating the physical response of an autonomous vehicle to the control signals 109.

Alternatively, a simpler form of simulation assumes that the ego agent follows each planned trajectory exactly between planning steps. This approach bypasses the control system 108 (to the extent it is separable from planning) and removes the need for the ego vehicle dynamic model 204. This may be sufficient for testing certain facets of planning.

To the extent that external agents exhibit autonomous behaviour/decision making within the simulator 202, some form of agent decision logic 210 is implemented to carry out those decisions and determine agent behaviour within the scenario. The agent decision logic 210 may be comparable in complexity to the ego stack 100 itself or it may have a more limited decision-making capability. The aim is to provide sufficiently realistic external agent behaviour within the simulator 202 to be able to usefully test the decision-making capabilities of the ego stack 100. In some contexts, this does not require any agent decision making logic 210 at all (open-loop simulation), and in other contexts useful testing can be provided using relatively limited agent logic 210 such as basic adaptive cruise control (ACC). One or more agent dynamics models 206 may be used to provide more realistic agent behaviour if appropriate.

A scenario is run in accordance with a scenario description 201, which typically has both static and dynamic elements. The static element(s) typically include a static road layout. The dynamic element(s) typically include one or more external agents within the scenario, such as other vehicles, pedestrians, bicycles etc. Scenario runs are orchestrated by a test orchestration component 260.

The extent of the dynamic information provided to the simulator 202 for each external agent can vary. For example, a scenario may be described by separable static and dynamic layers. A given static layer (e.g. defining a road layout) can be used in combination with different dynamic layers to provide different scenario instances. The dynamic layer may comprise, for each external agent, a spatial path to be followed by the agent together with one or both of motion data and behaviour data associated with the path. In simple open-loop simulation, an external actor simply follows the spatial path and motion data defined in the dynamic layer that is non-reactive i.e. does not react to the ego agent within the simulation. Such open-loop simulation can be implemented without any agent decision logic 210. However, in closed-loop simulation, the dynamic layer instead defines at least one behaviour to be followed along a static path (such as an ACC behaviour). In this case, the agent decision logic 210 implements that behaviour within the simulation in a reactive manner, i.e. reactive to the ego agent and/or other external agent(s). Motion data may still be associated with the static path but in this case is less prescriptive and may for example serve as a target along the path. For example, with an ACC behaviour, target speeds may be set along the path which the agent will seek to match, but the agent decision logic 210 might be permitted to reduce the speed of the external agent below the target at any point along the path in order to maintain a target headway from a forward vehicle.

The output of the simulator 202 for a given simulation includes an ego trace 212a of the ego agent and one or more agent traces 212b of the one or more external agents (traces 212). Each trace 212a, 212b is a complete history of an agent's behaviour within a simulation having both spatial and motion components. For example, each trace 212a, 212b may take the form of a spatial path having motion data associated with points along the path such as speed, acceleration, jerk (rate of change of acceleration), snap (rate of change of jerk) etc.

Additional information is also provided to supplement and provide context to the traces 212. Such additional information is referred to as “contextual” data 214. The contextual data 214 pertains to the physical context of the scenario, and can have both static components (such as road layout) and dynamic components (such as weather conditions to the extent they vary over the course of the simulation).

The test oracle 252 receives the traces 212 and the contextual data 214, and scores those outputs in respect of a set of performance evaluation rules 254. The performance evaluation rules 254 are shown to be provided as an input to the test oracle 252.

The rules 254 are categorical in nature (e.g. pass/fail-type rules). Certain performance evaluation rules are also associated with numerical performance metrics used to “score” trajectories (e.g. indicating a degree of success or failure or some other quantity that helps explain or is otherwise relevant to the categorical results). The evaluation of the rules 254 is time-based-a given rule may have a different outcome at different points in the scenario. The scoring is also time-based: for each performance evaluation metric, the test oracle 252 tracks how the value of that metric (the score) changes over time as the simulation progresses. The test oracle 252 provides an output 256 comprising a time sequence 256a of categorical (e.g. pass/fail) results for each rule, and a score-time plot 256b for each performance metric, as described in further detail later. The results and scores 256a, 256b are informative to the expert 122 and can be used to identify and mitigate performance issues within the tested stack 100. The test oracle 252 also provides an overall (aggregate) result for the scenario (e.g. overall pass/fail). The output 256 of the test oracle 252 is stored in a test database 258, in association with information about the scenario to which the output 256 pertains.

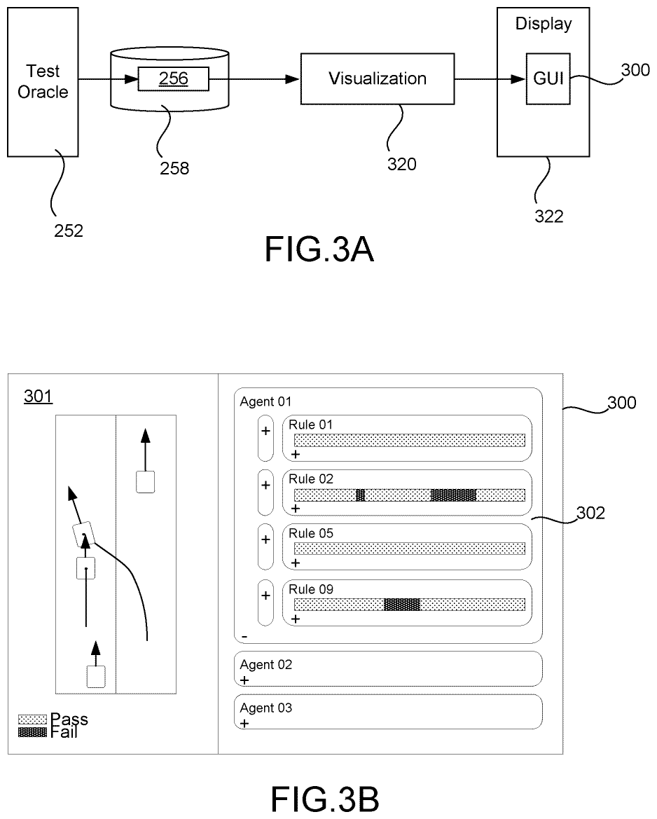

FIG. 3A shows a schematic block diagram of a visualization component 320. The visualization component 320 is shown having an input connected to the test database 258 for rendering the outputs 256 of the test oracle 252 on a graphical user interface (GUI) 300. The GUI is rendered on a display system 322.

FIG. 3B shows an example view of the GUI 300. The view pertains to a particular scenario containing multiple agents, and is shown to comprise a scenario visualization 301 and a set of driving performance assessment results 302. In this example, the test oracle output 526 pertains to multiple external agents, and the results are organized according to agent. For each agent, a time-series of results is available for each rule applicable to that agent at some point in the scenario. Colour coding is used to differentiate between periods of pass/fail on a particular rule.

### Scenario Query Engine

The scenario descriptions 116, 148, 201 described above are typically highly detailed. A high level of precision is required of the 3D road and lane geometry, typically to centimetre precision. A complex driving scenario might involve a network of roads and junction(s). It is often inefficient and time consuming to extract a required piece of information from a scenario description directly. To this end, a scenario query engine is provided, which allows fast processing of structured queries to be performed on a driving scenario description. The scenario query engine has many applications, including online applications of the kind depicted in FIG. 1A and offline applications of the kind depicted in FIGS. 1C and 2.

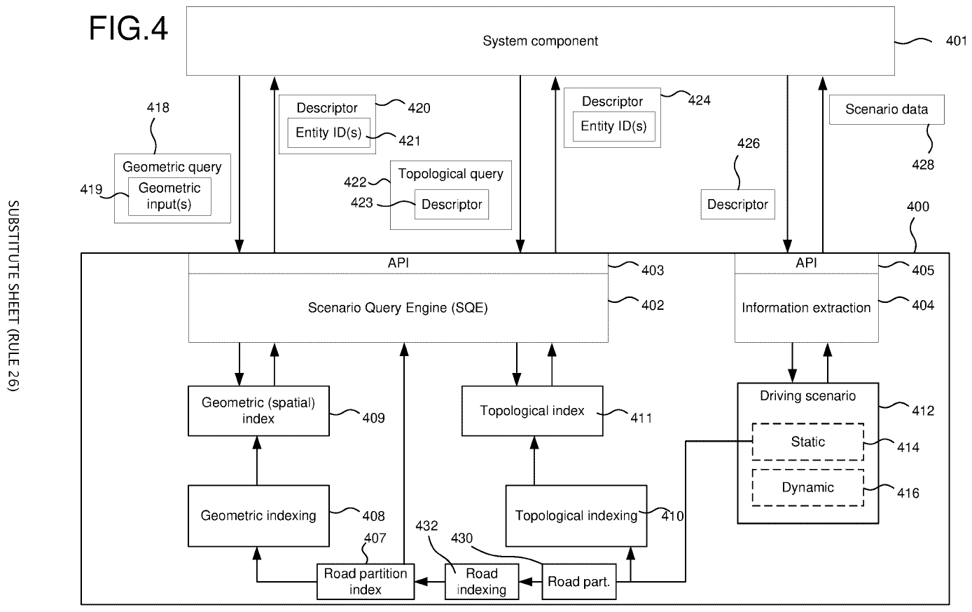

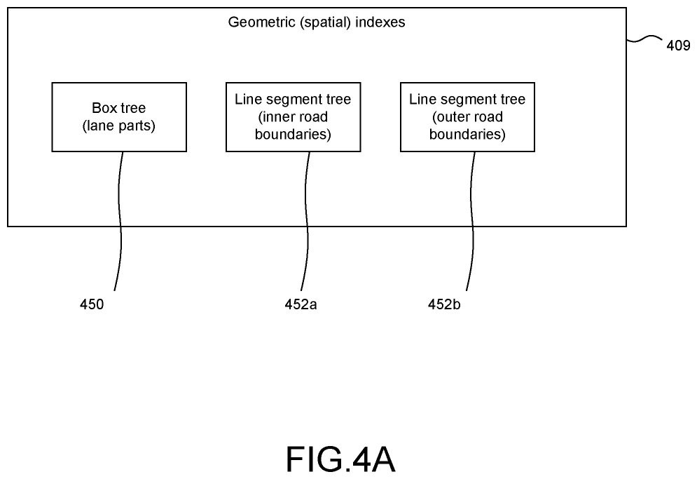

FIG. 4 shows a schematic block diagram of a scenario access system 400. The scenario access system 400 provides optimized information retrieval on behalf of other system components that require access to a driving scenario description 412.

The scenario description 412 is shown to have both static and dynamic layers 414, 416. In this example, the static layer 414 is encoded in a specification (document) that conforms to the OpenDRIVE schema, or some variant of OpenDRIVE (or other structured scenario description format), and the dynamic layer 416 is encoded using OpenSCENARIO.

The scenario access system is shown to comprise a scenario query engine (SQE) 402 and an extraction component 404. The SQE 402 is called via a first application programming interface (403) and the information extraction component 404 is called via a second API 405.

The first API 403 provides a set of scenario query functions that can be flexibly combined to perform complex queries on the driving scenario 412, and the second API 405 provides a set of information extraction functions for selectively extracting information from the driving scenario 412. A system component 401 built on top of the APIs 403, 405 is depicted. Different system components can be built on the APIs 403, 405 in this manner, reducing the burden on software developers. The system component 401 could, for example, be a component of the online stack 100 (such as the planning or prediction system 104, 106, or some component thereof) or an offline component (such as the simulator 202 within the testing pipeline 200).

The SQE 402 accepts both “geometric” and “topological” queries on the scenario description 412. Various scenario query functions provide results in the form of “descriptors” that allow information to be located in the underlying scenario description 412. The following examples consider geometric and topological queries on the static layer 414.

A geometric query 418 indicates one or more geometric constraints 419 (geometric inputs), and returns a response 420 in the form of a descriptor that identifies one or more road structure elements that satisfy the geometric constraints 419.

A descriptor comprises an identifier of each road structure entity that allows the corresponding section of the static layer 412 (that is, the section describing that road structure element) to be located (denoted by reference numeral 421 for the descriptor 420). A descriptor may contain additional information about the road structure element(s) satisfying the query. For example, the geometric inputs 419 might define a point or box (rectangle), and the response might indicate any road structure element(s) that intersect that point or box.

To facilitate geometric queries, a geometric indexing component 408 is provided. The geometric indexing component 408 builds a geometric (spatial) index 409 of the static layer 414 of the scenario description 412. The geometric index 409 is an in-memory data structure that maps geometric inputs to corresponding road structure elements within the scenario description 412. In the following examples, “roads” and “lanes” are the main types of road element considered. As described in further detail below, in OpenDRIVE, roads are described in terms of <road> elements and lanes are described in terms of <lane> elements. Although a single geometric index 409 is depicted, separate geometric indexes may be provided for different types of road structure element, for example separate spatial indexes for road and lanes.

To support efficient geometric querying, novel “road part” and “lane part” concepts are introduced. These concepts and their manner of utilization are described in Table 1 below.

The geometric index 409 is two-dimensional (2D), defined in a birds-eye-view plane of the road network. The static layer 414 may be 3D (e.g. to describe varying road elevation), even when the geometric index 409 is 2D. In other implementations, the geometric index 409 is three dimensional. Three-dimensional spatial indices may be useful e.g. in addressing ambiguity inherent in a plan view associated with under/over passes (where one road passes under another, leading to ambiguity in a 2D plan view).

Whilst the geometric index 409 is depicted as a single element in FIG. 4, in the described implementations, the API 403 is supported by a collection of geometric indexes.

FIG. 4A shows multiple geometric indexes, namely a bounding box tree 450, an inner boundary line segment tree 452a and an outer boundary line segment tree 452b, each of which is described in detail below.

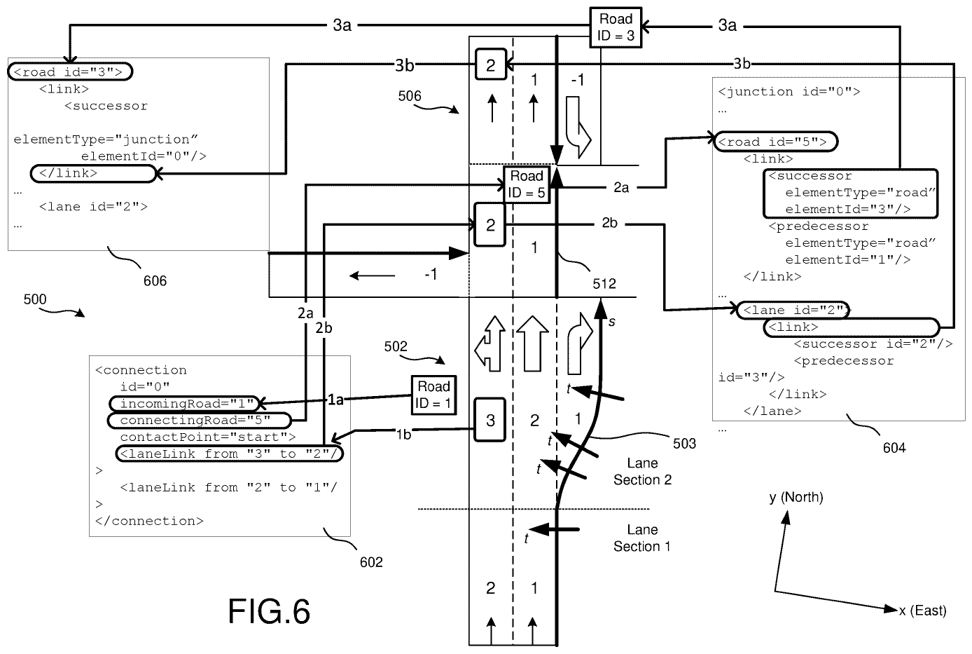

A topological query 422 includes an input descriptor 423 of one or more road structure elements (input elements), and returns a response in the form of an output descriptor 424 of one or more road structure elements (output elements) that satisfy the topological query because they have some defined topological relationship to the input elements. For example, a topological query might indicate a start lane and destination lane, and request a set of “micro routes” from the start lane to the destination lane, where a micro route is defined as a sequence of traversable lanes from the former to the latter. This is an example of what is referred to herein as “microplanning” (see FIG. 6 for further details). Different topological query types may be defined for different types of topological relationships.

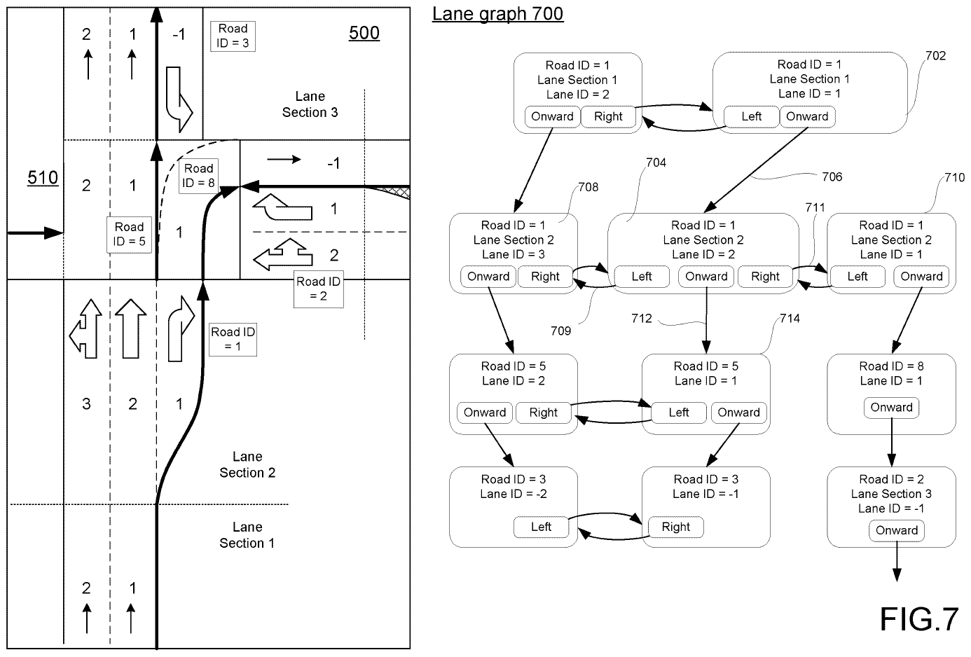

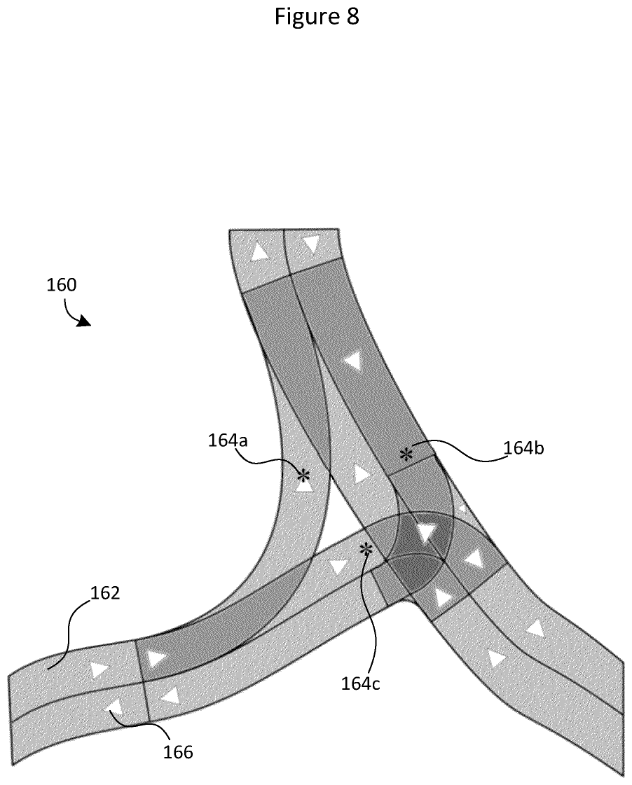

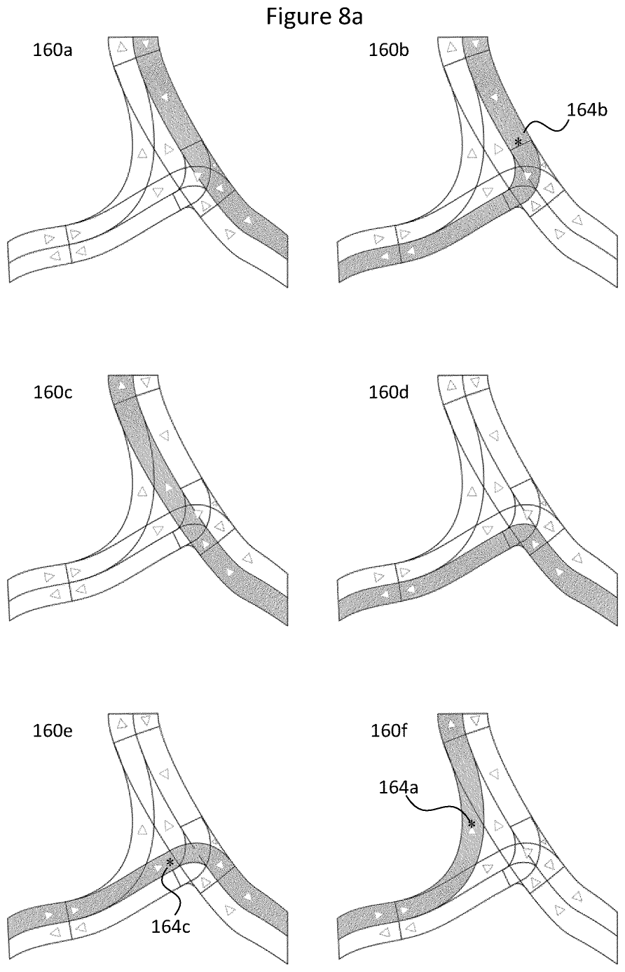

To facilitate topological queries, a topological indexing component 410 builds a topological index 411 of the static layer 414. The topological index 411 is an in-memory graph of road structure elements. Nodes of the graph encode structure elements and edges of the graph represent code topological relationships between the road structure elements. The nodes are embodied in memory as addressable memory locations and the edges as in-memory points to the corresponding memory addresses. Although a single index is depicted, in the examples below, separate topological indexes—a “road graph” and a “lane graph”—are constructed. See FIGS. 7 and 8 for further details.

The second API 426 maps information provided in a descriptor 426 to the corresponding section(s) of the scenario description 412. In response to a descriptor 426 of the static layer 416, the information extraction component 404 provides one or more pieces of scenario data 428 extracted from the corresponding section(s) of the static layer 414. For example, given a descriptor 426 indicating a particular lane, the information extraction component 404 would be able to provide, say, the 3D geometry of the lane from the static layer 414 or some associated piece of information from the dynamic layer 416 (e.g. indicating any agents whose starting locations lie within a particular road or lane).

Geometric and topological queries can be flexibility combined. For example, starting with some geometric constraint(s), a geometric query can return the description of corresponding road(s) or lane(s) (e.g. to find the lane containing the point x). The latter can then be used as the basis for a topological query (e.g. to find all lanes connected to the lane containing the point x).

Both geometric and topological queries return results in a form that can be interpreted in the context of the original static layer 414. A descriptor 420 returned on a geometric query 418 maps directly to the corresponding section(s) in the static layer 414 (e.g. a query for the lane intersecting the point x would return a descriptor that maps directly to the section describing the lane in question). The same is true of topological queries.

Whilst FIG. 4 depicts a driving scenario 412 with both static and dynamic layers 416, the techniques can be applied to a description of a static road layout with no dynamic layer.

A road partition index 407 is also shown, which is generated by a road indexing component 432 and is described in detail below. The road partition index 407 is used to build the geometric index 408, and also to support certain modes of query directly at the SQE API 403. The road indexing component 432 is supported by a road partitioning component 430, whose functionality is described below.

Certain novel concepts underpinning geometric queries within the SQE 402 are summarized in Table 1 below. The concepts are not found in the OpenDRIVE schema, and have been introduced to allow geometric queries to be constructed so that they can be processed quickly.

Table 2 summarizes the construction of the various indexes shown in FIGS. 4 and 4A.

Table 3 summarizes how these indexes are used to support certain modes of query at the SQE API 403.

Tables 1 to 3 refer to certain OpenDRIVE concepts, and further description of these OpenDRIVE concepts follows Table 3. Whilst OpenDRIVE is used as a reference point, the described techniques can be applied to other road network schemas, with the same benefits as set out herein.

TABLE 1
Summary of additional concepts.

| Concept | Description |
|---|---|
| Road | Applicable to road network schemas, such as OpenDRIVE, in which road/lane boundaries |
| part. | are encoded in terms of multiple functions that can change at arbitrary points along the |
| | road. The number of functions may also change e.g. as the number of lanes changes. A |
| | road part refers to an s-coordinate interval in which the road is described by a single |
| | fixed subset of the functions of interest. In other words, within any given road part no |
| | change occurs in any of the functions of interest along the length of the road part (and |
| | the number of functions does not change). |
| | For example, a road reference line might be defined as a straight line function (f1) on the |
| | interval [0, s2) (its support), a spiral function (f2) on the interval [s2, s3) and an arc |
| | function (f3) on the interval [s3, s5]. The interval [0, s1) could span a first lane section |
| | with a single side-lane (ID 1) of constant width (constant width function f4). At s1, a new |
| | lane section might begin with two side-lanes (ID 1 and 2), with the width of Lane 2 |
| | described by a function f5 linearly increasing from zero in the interval [s1, s4), and then |
| | by a constant width function f6 in the interval [s4, s5]. For simplicity of illustration, it is |
| | assumed that the width of Lane 1 remains constant throughout, described by f4. In this |
| | case, one viable partitioning of the road that satisfies the above requirements is: |
| | ([0, s1), [s1, s2), [s2, s3), [s3, s4), [s4, s5]). |
| Lane | A lane part refers to a side-lane within a road part in the above sense (an s-interval in |
| part. | which no function of interest changes and the number of functions does not change). A |
| | lane part may be described by a “bundle” comprising a road partition identifier (e.g. s- |
| | rage of the partition) and a lane ID. |
| | So, in the above example, there are nine lane parts in total - a single lane part being the |
| | lane with ID 1 in the interval [0, s1), with two lane parts in each of the subsequent |
| | intervals being the portions of the lanes with ID 1 and 2 respectively contained within |
| | that interval. Note the partitioning of the lanes is defined by the partitioning of the road |
| | as a whole, which in turn is defined by the supports of the full set of functions of interest. |

TABLE 2
Summary of indexes.

| Index | Description |
|---|---|
| Topological | A directed graph (side-lane graph) in which nodes represent side-lanes and edges |
| index 411. | between nodes represent directed lane connections between side-lanes (which may or |
| | may not be drivable; e.g. it may be useful to find a sequence of side-lanes navigable by |
| | pedestrians). In this context, the term “lane change” is used in a broader sense, and can |
| | include not only left/right lane changes, but also “onward” lane changes from one lane |
| | to its immediate successor/predecessor (staying in lane from the driver's perspective, |
| | whilst crossing a boundary between connected roads/junctions/lane sections etc. of |
| | the road network). The existence of a path through the graph from a first node to a |
| | second node implies the existence of a drivable route from the former to the latter, |
| | expressed as the corresponding sequence of side-lanes (micro-route) to be driven by a |
| | vehicle. |
| | Each edge may be associated with a cost that is representative of driving distance |
| | incurred by the corresponding lane change. For a left/right lane change, the cost would |
| | generally depend on lateral distance from a current lane to its left/right neighbour. For |
| | an onward lane change from a current lane to an onward lane, the cost would generally |
| | depend on the length (longitudinal extent) of the current lane (which would have to be |
| | driven to reach the onward lane). |
| | By and large, there is a one-to-one mapping between nodes in the topological index |
| | and side-lanes in the underlying OpenDRIVE layout, which is desirable to maintain a |
| | close alignment with the underlying road network representation. Bi-directional side- |
| | lanes are an exception to this one-to-one mapping: a bi-directional lane is represented |
| | as two separate nodes in the topological index, one for each driving direction. |
| | In the described implementations, the topological index does not leverage the road part |
| | and lane part concepts introduced above; rather, these are only utilized in the |
| | construction and processing of geometric queries. |
| | See FIG. 7. |
| Road | Addresses schemas, such as OpenDRIVE, in which road/lane boundaries are encoded in |
| partition | terms of multiple functions that can change at arbitrary points along the road. The |
| index 407. | number of functions may also change e.g. as the number of lanes changes. To build a |
| | road partition index, a road is partitioned, as set out above, based on the supports of |
| | the multiple functions of interest, such that each road part is described by a single fixed |
| | subset of the functions of interest. In other words, each road part is chosen such that |
| | no change occurs in any of the functions of interest along the length of the road part |
| | (and the number of functions does not change). The road partition index has an entry |
| | for each road part, which in turn contains reference(s) to the subset of the functions of |
| | interest that describe that road part. |
| | Taking the above example, suppose the functions of interest are those describing the |
| | road reference line and the functions describing the lane widths (this is a simplified |
| | example for the sake of illustration). In that case, one viable construction of the road |
| | partition index is: |
| | [0, s1): (Ref_f1, Ref_f4) |
| | [s1, s2): (Ref_f1, Ref_f4, Ref_f5) //no. of lanes increases. |
| | [s2, s3): (Ref_f2, Ref_f4, Ref_f5) //road ref. line fn. changes to f2. |
| | [s3, s4): (Ref_f3, Ref_f4, Ref_f5) //road ref. line fn. changes to f3. |
| | [s4, s5]: (Ref_f3, Ref_f4, Ref_f6) //Lane 2 width fn. changes to f6. |
| | Computation of the lane boundaries requires the road reference line and the lane width |
| | functions (the lane width function for Lane 1 defines its geometry relative to the road |
| | reference line; the lane width function for Lane 2, in turn, defines the geometry of Lane |
| | 2 relative to that of Lane 1). In the above example, it is guaranteed that the full set of |
| | lane boundaries can be computed for any given road part with a single subset of |
| | functions. |
| | The road partition index provides extremely fast processing of queries on specified road |
| | parts. Such a query might contain an identifier of a road part (e.g. its s-interval) or a |
| | bundle describing a lane part (lane ID, road part ID) and ask for, say, the (s, t) coordinates |
| | on the road of a given (x, y) point, the closest point on a lane mid-line to a given (x, y) |
| | point, or to determine whether a point or box is contained within a given road or lane |
| | part. Such queries on the road partition index could be “internal” (see e.g. |
| | “containment queries” below) or “external” (meaning that the information identifying |
| | the road or lane part is provided at the SQE API). |
| | Only a single set of functions is needed to answer such queries, namely the subset of |
| | functions referenced in the corresponding entry of the road partition index. The query |
| | can be answered quickly, because it is guaranteed by design that the subset of functions |
| | needed to do so will not change within the partition in question. |
| Bounding | A spatial (geometric index) that can be used, among other things, to support fast |
| box tree | “containment” queries (e.g. a query that provides a point or box, and asks for all side- |
| 450. | lane(s) intersecting the point/box). Each leaf node contains a bounding box of a lane |
| | part (a lane or lane portion within a road part) and a bundle uniquely identifying the |
| | lane part, namely a lane ID, and some reference to the entry in the road partition index |
| | for the corresponding road part (e.g. the s-coordinate interval for the road part or some |
| | other identifier of the road part that can be used to locate the entry in the road partition |
| | index). |
| | The “internal” parent/child structure of the tree is not required to have any specific |
| | correspondence to the road structure, in that leaf nodes can be grouped in any way to |
| | support fast queries (which would typically mean grouping together nearby boxes). A |
| | self-balancing tree may be used that adapts parent/child relationships dynamically. |
| | The road partition index is used to build the bounding box tree. Recall that each leaf |
| | node corresponds to a single lane part. In order to compute the bounding box of the |
| | leaf node, the geometry of the lane part is first computed using the single set of fixed |
| | functions referenced in the road partition index. It is then straightforward to compute |
| | bounding box coordinates for the lane part in question. The leaf node is populated with |
| | the bounding box coordinates, and a bundle comprising the lane ID and a reference to |
| | the corresponding road part in the road partition index. |
| Line | A spatial (geometric index) that can be used, among other things, to support fast |
| segment | “distance” queries (e.g. a query that provides a point for the closest side-lane(s) to the |
| tree(s) 452a, | point). Each leaf node contains a straight line segment that approximates a boundary |
| 452b. | on a given interval, which is fully contained within a single road part (that is, no line |
| | segment crosses the boundary between different road parts). In the described |
| | implementation, each line segment is computed for a single boundary within a sub- |
| | interval of a given road part, where the size of the sub-interval decreases with road/lane |
| | curvature to maintain a certain level of accuracy in the line segment approximation. |
| | Each leaf node also contains a bundle describing the lane part to which it belongs (which |
| | may result in significant duplication of references across the leaf nodes of the tree, |
| | particularly with narrow sub intervals). |
| | In the described implementation, two separate line segment trees are built on inner |
| | and outer boundaries respectively. Within a road, most lines serve as both inner and |
| | outer boundaries - e.g. in a road with Lanes 1 and 2, the outer boundary of Lane 1 is |
| | the inner boundary of Lane 2. The outer boundary of the outermost lane is not an inner |
| | boundary. In a two-way road, the boundary between Lane 1 and Lane −1 is not an outer |
| | boundary, but is the inner boundary to both Lane 1 and Lane −1, and its line segments |
| | are indexed twice in the inner boundary tree 452b (in association with Lane 1 and |
| | Lane −1 respectively). |
| | In the inner boundary tree 452a, each leaf node contains a line segment, a bundle |
| | describing the lane part of which that line segment is an inner boundary. In the outer |
| | boundary tree 452b, each leaf node contains a line segment, a bundle describing the |
| | lane part of which that line segment is an outer boundary. A given line segment may |
| | appear in both trees, but with different lane IDs and flags. |
| | Each direct parent node of a set of leaf nodes contains a bounding box around all line |
| | segments of its child nodes, and each parent of non-leaf nodes contains a bounding box |
| | around the bounding boxes of children. |
| | The “internal” parent/child structure of the tree is not required to have any specific |
| | correspondence to the road structure, in that leaf nodes can be grouped in any way to |
| | support fast queries (which would typically mean grouping together nearby line |
| | segments at the leaf level, and near boxes higher up the tree). Line segments from |
| | different road parts may therefore be grouped together under the same direct parent. |
| | A self-balancing tree may be used that adapts parent/child relationships dynamically. |
| | The road partition index is used to build the bounding box tree. Recall that each leaf |
| | node corresponds to a line segment contained within a single road part. The line |
| | segment is computed using the single set of fixed functions referenced in the road |
| | partition index. It is then straightforward to compute bounding box coordinates for all |
| | line segments under a common parent node, and to compute bounding boxes for |
| | parent nodes higher up the tree. |

TABLE 3
Summary of query modes.

| | Supporting | |
|---|---|---|
| Query mode | indexes | Description |
| Containment. | Bounding box | A containment query is answered in two phases. The box tree is |
| | tree (phase 1); | first used to obtain a set of candidate lane part(s), whose bounding |
| | Road partition | box(es) intersect the point/box in question. This is not definitive, |
| | index (phase | as a bounding box for a given lane part will, in most cases, span one |
| | 2). | or more regions outside of the lane part. The second phase of the |
| | | query uses the road partition index to answer the query |
| | | definitively. Recall that each leaf node contains the bundle for the |
| | | lane part in question. This, in turn, allows the required functions |
| | | to be retrieved using the road partition index (an “internal” query |
| | | on the road partition index, triggered by the containment query). |
| | | By design, this is a single set of functions that does not change |
| | | within the road/lane part. Using this single set of functions, the |
| | | required geometry of each candidate lane part can be computed |
| | | to any desired accuracy, and used to answer the query in respect |
| | | of that lane part definitively. |
| | | The response to a containment query provides the bundle(s) |
| | | describing the lane part (or each lane part) satisfying the query. |
| | | The bundle can, in turn, be used in a further external query |
| | | pertaining to the road/lane geometry on the road partition index |
| | | (see “road partition queries” below) |
| | | A containment query returns a null response if the point/box does |
| | | not intersect any side-lane. A containment query may also be type- |
| | | specific, in which case a null response is returned if the point/box |
| | | is not contained within any side-line of the specified type (even if |
| | | it is contained within a side-lane of some other type). |
| Distance. | Line segment | A distance query asks for the closest side-lane to a given (x, y) point |
| | tree(s). | or box. A distance query may be type-specific, and ask for the |
| | | closest side-lane of a type specified by a set of query flag(s). |
| | | In general, one has to find both the nearest inner and outer |
| | | boundary and then chose that which is closest (assuming that the |
| | | query point is not covered by the relevant sub-set of side-lanes). |
| | | In the specific case of a distance query that is not type-specific, the |
| | | SQE 402 assumes the given point (or box) is not contained in any |
| | | side-lane, and therefore lies outside the boundaries of the road. In |
| | | this case, it is sufficient to find the closest outer boundary line |
| | | segment to (x, y) via a search on the outer boundary tree only. |
| | | Therefore, before making the distance query, generally a non-type- |
| | | specific containment query should be run (unless it is already |
| | | known that the point (x, y) lies outside of the road boundaries), and |
| | | the distance query should only be run if the containment query |
| | | returns a null result. |
| | | To respond to a type-specific distance query, similar principles |
| | | apply, in so far as the SQE assumes the point (x, y) (or box) is not |
| | | contained in a side-lane of the specified type, although a search is |
| | | required on both trees (see above). Therefore, generally speaking, |
| | | a type-specific containment query should be run first, and the type- |
| | | specific distance query should only be run if this returns a null |
| | | result. |
| | | Geometric rules are constructed for identifying viable branches of |
| | | a line segment tree based on parent bounding boxes. Given a set |
| | | of parent bounding boxes at a particular level in the tree, it is |
| | | generally possible to exclude most of these, on the basis that they |
| | | could not possibly contain the closest line segment to the point |
| | | (x, y). |
| | | The above assumptions leverage the respective benefits of the box |
| | | tree and the line segment tree(s). A containment query can be |
| | | answered more efficiently with a search on the box tree, whereas |
| | | a distance query can be answered efficiently on the line segment(s) |
| | | in the case that lack-of containment does not need to be verified. |
| | | Of course, distance and containment could be contained in a single |
| | | API query. Such a query would be answered first with a search on |
| | | the containment tree and road partition index to ascertain |
| | | containment (type-specific or non-type specific), in the same way |
| | | as a containment query, followed by a search on the line segment |
| | | tree(s) in the case of a null containment result. |
| | | The response to a distance query provides the bundle(s) describing |
| | | the lane part (or each lane part) satisfying the query. The bundle |
| | | can, in turn, be used in a further query pertaining to the road/lane |
| | | geometry on the road partition index (see “road partition queries” |
| | | below). |
| Road | Road partition | A broad class of query that can be answered from the road |
| | | partition index directly. A “road partition query” contains an |
| | | identifier of a road part (e.g. s-interval) or a bundle describing a |
| | | lane part (lane ID, road part ID). Typically, this information would |
| | | be obtained via an earlier containment or distance query. These |
| | | are “external” queries on the road partition index, in that the |
| | | road/lane part in question is specified in a query at the API (in |
| | | contrast to the internal query on the road partition index in the |
| | | second phase of responding to a containment query). |
| partition. | index. | Examples include a query to to find corresponding (s, t) coordinates |
| | | in a specified road part of a given (x, y) point, to find the closest |
| | | point to (x, y) on the midline of the lane part etc.), again leveraging |
| | | the performance benefits of the road partition index. |
| Route | Topological | A query that returns a micro-route from a first specified side-lane |
| planning. | index. | to a second specified side-lane having lowest overall costs. The |
| | | SQE performs a search on the topological index to find the lowest- |
| | | cost path through the tree from the node of the first side-lane to |
| | | the node of the second-side lane. Any cost-based tree search can |
| | | be used (a depth first search is used in the described |
| | | implementation). |
| | | To obtain the first and second side lanes, geometric queries can be |
| | | used e.g. to find the side-lane containing a given point/box or the |
| | | closest side lane to a given point/box. |

For type-specific queries using the above trees, any side-lane attributes that are required are retrieved direct from an in-memory representation of the document containing the static layer 414. A predicate is applied to the entire tree and only those indexed values that satisfy the predicate are considered. A range of predicates may be supported (e.g. lane-type, supporting road-type (in-junction or not), etc.) and arbitrary combinations may also supported, e.g. ‘get me the nearest side-lane that is a driving or a biking lane that is in a junction’.

Road/lane attributes are not stored within the spatial indices in the described examples (but could be in other implementations). Rather, the index is first filtered based on the active predicate(s) and the query is run on the filtered index (such that element that do not satisfy the active predicate(s) are not considered in processing the query).

As will be appreciated, the specific choices of index and query types summarized above are not intended to be exhaustive, but are merely illustrative of how the techniques may be applied in a particular implementation.

### Example Road Network:

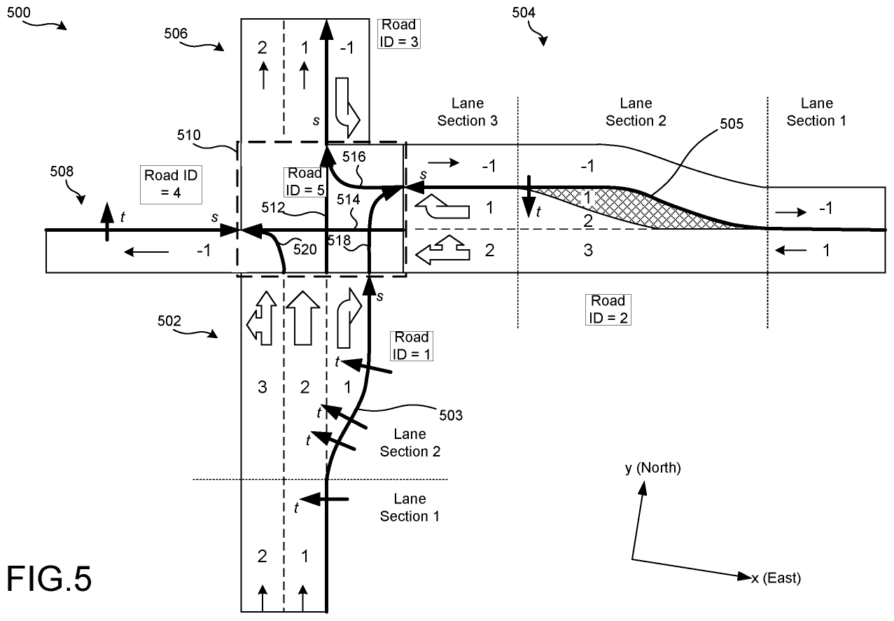

FIG. 5 schematically depicts an example road network 500 of the kind encoded in the static layer 414. The following description assumes the road network 500 is described using the OpenDRIVE schema, or a similar format that adopts certain definitions and conventions from OpenDRIVE. However, it will be appreciated that the principles extend more generally to other formats, and the described techniques are not limited to any particular data format or schema.

The road network 500 is shown to comprise first, second, third and fourth roads 502, 504, 506, 508 (Roads 1 to 4), which are described with <road> elements having road identifiers (IDs) 1, 2, 3 and 4 respectively. The roads 502-508 are interconnected via a junction 510 described by a <junction> element. Each of the roads 502-508 is defined by a single road reference line, denoted as a thick solid arrow, and contains a single center lane of width zero. The center lanes are not depicted separately, and for simplicity it is assumed that the center lane of each road 502-508 lies along the road reference line (although, as noted, it is possible to define a non-zero offset between the road reference line and the center lane). The road reference lines of the first and second roads 502, 504 are denoted by reference numerals 503 and 505 respectively. A road reference line is directional, and could be described more precisely as a longitudinal axis or “s-axis” of the road, with s-coordinates running along that axis, and t-coordinates running orthogonal to it. As depicted for the reference lines 503, 505, the positive t-direction is defined as extending to the left of the s-axis.

A left-hand traffic (LHT) road system is depicted in this example. However, the schema can be used for either LHT or right-hand traffic (RHT) networks. A “rule” attribute of each <road> element indicates whether the road is LHT (vehicles drive on the left) or RHT (vehicles drive on the right).

A global cartesian coordinate system is defined with the x-direction lying eastwards and the y-axis extending northwards (OpenDRIVE calls this the inertial coordinate system).

Lane numbers only indicate relative directions of traffic flow within a road: for any given road, traffic flows in the same direction for positively-numbered one-way side-lanes, and in the opposite direction for negatively-numbered one-way side-lanes. Bi-directional lanes support traffic flow in both directions irrespective of the road traffic rule. However, the lane number alone is not sufficient to infer the direction of traffic flow, as the direction of the s-axis can be (more or less) arbitrarily chosen and does not indicate driving direction. For example, in FIG. 5, the s-axis 505 of the second road 504 extends towards the junction from the east, whilst the s-axis of the fourth road 508 extends in the opposite direction towards the junction 510 from the west. Along the second road 504, positive lane numbers therefore denote a direction of traffic flow from east to west, whereas along the fourth road 508, east-to-west traffic flow is denoted by negative lane numbers. For a LHT road, lanes to the left of the road reference line (+t) carry traffic in the direction of the road reference line (+s), whereas lanes to the right of the road reference line (−t) carry traffic in the opposite direction (−s). In an RHT road, lanes to the left of the road center line (+t) carry traffic in the opposite direction of the road reference line (−s) and lanes to the right (−t) carry traffic in the direction of the road reference line (+s).

It is also possible to define a bidirectional side-lane, permitting traffic flow in both directions, by setting a @type attribute of the <lane> element to “bidirectional”. Bidirectional lanes are addressed in more detail below.

Therefore, in order to determine the absolute direction of traffic flow, the lane number is not sufficient; the direction of the road reference line (s-axis) must also be considered, as must the @type attribute.

Lanes are not necessarily drivable. For example, Lane 1 of Lane Section 2 of Road 2 is non-drivable. The outer boundaries of a road may also be defined by non-drivable lanes (such as lanes of a pavement/sidewalk type).

Link elements are used to explicitly define linkage between roads and lanes. With only two roads, links can be defined with link elements between roads directly, provided the links are unambiguous. More complex linkage requires the use of junction elements.

A <link> element can have one or both of a <successor> element and a <predecessor> element. The predecessor/successor of a road can be another road or a junction. The predecessor/successor of a lane is another lane. “Predecessor” and “successor” relationships are defined relative to the s-axis of the road in question (a road's t-axis runs from its predecessor, if any, to its successor, if any), and do not denote driving direction. The s-axis of a road runs away from its predecessor (if any), towards its successor (if any).

Predecessor/successor relationships may be ‘asymmetrical’. For example, if Road n is a predecessor of Road m, that does not imply Road m is a successor of Road n; if the s-axis of Road n runs in the opposite direction to the s-axis of Road m, then Road m could also be a predecessor of Road n. As another example, if Road m is part of a junction, then Road m cannot be a predecessor or successor of Road n, because the junction would be the predecessor/successor of Road n instead (see below for further examples).

Within the junction element 510 of Figure, additional roads are defined, whose reference lines are depicted as thick, solid arrows. Fifth to ninth roads 512, 514, 516, 518, 520 (Roads 5 to 9) are depicted within the junction 510 in this example. Although side-lanes within the junctions 510 are not depicted in FIG. 5, each road within the junction 510 is also required to have at least one side-lane of non-zero width.

In FIG. 5, the junction 510 is a successor of the first, second and fourth roads 502, 504, 508 because their respective s-axes extend towards the junction 510. Therefore, the <road> elements describing those roads 502, 504, 508 would contain <link> elements with <successor> elements indicating the junction 510. The junction 510 is a predecessor of the third road 506 because its s-axis extends away from the junction, and the <road> element describing the third road 506 would therefore contain a <link> element with a <predecessor> element indicating the junction 510.

Within the junction element 510, connecting roads are described by <road> and <connection> elements.

The fifth road 512 (Road 5) is shown to connect the first and third roads 502, 506. The fifth road 512 is defined by a <road> element within the <junction> element 510, of which the first road 502 is a predecessor and the third road 506 is a successor (defined via <predecessor> and <successor> elements in the <road> element describing the fifth road 506). Similarly the sixth road 514 has the fourth road 508 as its successor and the second road 504 as its predecessor. The seventh road 516 connects the second and third roads 504, 506, with the second road 504 as its predecessor and the third road 506 as its successor. The eighth road 518 connects the second and first roads 504, 502, with the second road 504 as successor and the first road 502 as predecessor. Finally, the ninth road 520 connects the first and fourth roads 502, 508, with the fourth road 508 as its successor and the first road 502 as its predecessor. Again, the predecessor/successor relationships are not direct indicators of driving direction.

A<connection> element is used to indicate driving direction for traffic joining a junction. A connection element indicates an incoming road and a connecting road (but does not explicitly define an outgoing road), with traffic entering the junction from the incoming road onto the connecting road. For example, a first <connection> element would be provided that indicates the road with ID=1 (the first road 502) as an incoming road and the road with ID=5 (the fifth road 512) as a connecting road; this connection element indicates that traffic can enter the junction 510 from the first road 502 onto the fifth road 512. A second <connection> element would indicate the first road 502 as an incoming road and the eighth road 518 as a connecting road, etc. The seventh connecting road 516 is a two-way road in this example, carrying traffic from the second road 504 to the third road 506, and traffic in the opposite direction. Therefore, two <connection> elements would be used, one indicating the second road as incoming and the seventh road 516 as connecting, and the other indicating the third road 506 as incoming and the seventh road 516 as connecting. The OpenDRIVE specification strongly advises one not to use two-way connecting roads, although two-way connecting roads are possible using the schema. The seventh connecting road 516 goes against this advice, but does not violate it (and, in practice, it is more likely that two one-way connecting roads would be defined). The fourth road 508 is not an incoming road to the junction 510 (even though its s-axis extends towards the junction 510), because it is a one-way road that only carries traffic away from the junction 510.

A connecting road with multiple lanes is used when lane changes are possible within the junction 510; if lane changes are not permitted, multiple single-lane roads would be used instead.

A “virtual” connection can also be described using a <connection> element without any connecting road. Virtual connections are limited to “virtual” junctions, which do not require a main road to be split up.

There are many contexts in which it would be useful to determine a route through all or part of the road network 500 in terms of lanes. This is referred to herein as “microplanning”. The aim of micro planning is to determine one or more directed lane sequences (“micro routes”) that satisfy some given criteria (such as a current and target lane). Whilst it is often drivable side-lane sequences that are of interest, non-drivable sequences may be considered e.g. to route pedestrians.

FIG. 6 shows part of the road network 500 of FIG. 5, annotated with sections of OpenSCENARIO code that define certain elements of the road network.

Starting from any lane of any of the incoming roads 502, 506, 506, the <connection> elements within the junction describe all possible routes though the junction 510 (at the road level). For a given lane on a given road, obtaining a list of all routes through the junction would mean locating all of the <connection> elements that identify the road in question as an incoming road, via its road ID, and which also have a lane linked to the lane in question.

A first code portion 602 contains a connection element (connection ID=0) that indicates the first road 502 (the road with ID 1) as an incoming road and the fifth road 512 (the road with ID 5) as a connecting road. First and second <laneLink> elements link Lane 3 of Road 1 (its incoming road) to Lane 2 of Road 5, and Lane 2 of Road 1 to Lane 1 of Road 5. A second portion of code 604 contains the <road> element describing Road 5 within the junction 510 (junction ID=0). A<link> element within the road element contains both <successor> and <predecessor> elements. The road link in the predecessor element indicated Road 1 as the predecessor to Road 5, which mirrors the lane links in the corresponding <connection> element (Connection 0). The successor element indicates the third road 506 (the road with ID 3) as successor to Road 5. A<lane> element is also shown within the road element for Road 5, which describes Lane 2 of Road 5 (other lane elements are omitted for conciseness); the lane element contains a link element, which in turn indicates Lane 2 as its successor and Lane 3 as its predecessor. To meaningfully interpret the lane links, it is necessary to consider the road link information; Road 1 is the predecessor to Road 5, therefore Lane 3 of Road 1 is the predecessor of Lane 2 of Road 5; Road 3 is the successor to Road 5, therefore Lane 2 of Road 3 is the successor to Lane 2 of Road 5. A third code portion 606 contains the road element describing Road 3. The junction 510 (junction ID=0) is indicated as the predecessor to Road 3, and a lane element is shown that describes Lane 2 of Road 3 (other lane elements are omitted for conciseness).

As can be seen from the above example, extracting a relatively basic piece of information—in this case, the direct route though the junction from Lane 3 or Lane Section 2 of Road 1 to Lane 2 of Road 3—is fairly inefficient.

Moreover, for microplanning, it is not sufficient to simply consider lane links, as this would ignore other micro routes that involve lane changes. It is therefore necessary to consider lane changes separately. Lane numbering is useful here, because it allows adjacent lanes in the same driving direction to be identified. However, lane numbering is not necessarily determinative. For example, returning briefly to FIG. 5, it is not possible to move from Lane 2 of Road 2 to Lane 1 of Road 2 because the latter is non-drivable. Although not depicted in FIG. 5, additional lanes may be used to describe the boundaries of the road, such as border or shoulder lanes, or lanes which are only usable by certain forms of agent (such as bus or cycle lanes).

Moreover, OpenDRIVE accommodates bidirectional lanes, and it is, in principle, possible to change from a positively-numbered lane to a negative numbered lane, or vice versa, if the destination lane is bidirectional. That said, in this particular implementation, the topological index 411 (‘DirectedSideLaneGraph’) as exposed through the SQE API 403 does not support lane change transitions that cross the road center-line (even if the target lane were bi-directional). In any case, the topological index 411 guarantees that any available transition will be supported by consistent driving directions (a route will never be returned down a one-way street in the wrong direction).

### Lane Graph

FIG. 7 shows part of a directed side-lane graph 700 generated for the road network 500. The directed side-lane graph 700 is referred to simply as the lane graph 700 for conciseness. The lane graph 700 describes lane interconnections from Road 1 though the junction 510. As described above, the lane graph 700 is an in-memory data structure that serves as an index for topological queries.

The lane graph 700 is implemented in memory as a collection of vertex descriptors to refer to the vertices of the graph (the directed side-lane references) and a collection of edge descriptors to refer to links (directed edges) between them; each vertex descriptor is then associated with a collection of incoming edge descriptors and a collection of outgoing edge descriptors. These descriptors are separate from the publicly exposed descriptors shown in FIG. 4, but the vertex descriptors do correspond to the directed side-lane descriptors (that association is managed internally).

For example, first and second nodes 702, 704 correspond, respectively, to Lane 1 of Lane Section 1 of Road 1 and Lane 2 of Lane Section 2 of Road 1. An onward edge 706 indicates the topological relationship between those lanes, namely that the latter is an “onward” lane from the former (i.e. a vehicle can traverse from the former to the latter without performing a lane change maneuver). An edge descriptor is associated with the nodes 702, 704 that defines the directed edge from the former to the latter with an indication of edge type (“onward” in this case). A node or edge descriptor can be contained in a single memory address or multiple memory addresses (e.g. in a block of memory addresses).

The lane graph 700 is constructed by interpreting the code of the static layer 414. Note that edges of the lane graph denote driving direction. To determine onward edges, lane links need to be considered, but driving direction also needs to be considered.

Edges are also provided for left-right relationships. For example, third and fourth nodes 708, 710 are depicted, representing Lanes 3 and 1, respectively, of Lane Section 2 of Road 1. A right edge 711 from the second node 704 to the fourth node 710 represents the possibility of moving from Lane 2 to Lane 1 of that lane section via a right lane change maneuver. A left edge 709 from the second node 704 to the third node 708 represents the possibility of moving from Lane 2 to Lane 3 via a left lane change maneuver. The left and right edges 709, 711 are stored in memory as edge descriptors, with an indication of their respective types (“left” and “right”). This information is not provided in <link> elements of the underlying description, but is obtained from the structure of the road as explained above.

A fifth node 714 represents Lane 1 in the only road section of Road 5, which is an onward lane from Lane 2 in Lane Section 2 or Road 1. Therefore, an onward edge 712 is directed from the second node 704 representing the former to the fifth node 714 representing the latter.

As will be appreciated, there are various ways a graph structure of this nature can be encoded in memory, such that topological relationships within the road network 500 are encoded as in-memory pointers between nodes that represent road structure elements. Whilst FIG. 7 depicts a lane graph, a similar geometric index can be constructed at the road level, with nodes representing roads, and pointers representing topological relationships between the roads.

In the lane graph 700, a second lane is said to be connected to a first lane if there exists an edge from the first lane to the second lane (implying that it is possible to move from the first lane into the second lane). As indicated, this concept of “connections” in the lane graph is distinct from the concepts of links in OpenDRIVE.

Considering the microplanning query above, topological queries can be accommodated highly efficiently. For example, given a current lane and a goal lane, micro routes from the former to the latter can be easily determined as a set of paths through the lane graph 700 from the node representing the former to the node representing the latter.

Lane sections do not have explicit identifiers in OpenDRIVE. However, they are implicitly indexed by the order in which they appear in the applicable <Road> element. These implicit indices are used to reference Lane Sections within the SQE 402. Specifically, the SQE 402 uses a zero-based index of the lane-section in the road.lanes( ).lane_sections( ) collection.

FIG. 8 shows further details of part of the lane graph 700. Each edge has an associated cost stored in association with it. For example, the cost may be contained in the edge descriptor describing that edge. For the sake of illustration, the figure shows costs 709C, 711C and 712C associated with the left, right and onward edges directed from the second node 704 to the third, fourth and fifth nodes 708, 710, 714 respectively. Costs for other edges in the graph are not shown, but each edge of the lane graph 700 is associated with a cost in this manner.

The costs take the form of distance penalties that facilitate a fast search for the shortest micro-route from one node to another. In practice, this search will be approximate. For a given lane sequence, the actual distance travelled will, in practice, have some dependence on driver (or other actor) behaviour, such as the timing of lane change maneuvers, the extent of lateral movement within a lane etc., Nevertheless, it is possible to assign each edge of the graph 700 a cost that is generally representative of distance travelled.

When an onward edges in the directed side-lane graph 700 is traversed, a cost is incurred that is equal to the physical length of the source side-lane mid-line (measured from the beginning of the supporting lane-section). That is, for an onward edge from one lane to another, it is the length (longitudinal extent) of the former that is material. Thus, the distance penalty 712C associated with the onward edge from the second node 704 to the fifth node 714 depends on the length of Lane 2 in Lane Section 2 of Road 1. Conceptually, route planning from a given node (at the start of a route or along a route) begins at the start of the lane, as defined by driving direction. To reach an onward lane from the start of a current lane requires the given lane to be driven (or otherwise traversed) in order to reach the onward lane. Hence, to support this form of route planning, the cost of an onward edge from a current lane to an onward lane is given by the length of the current lane (not the onward lane), or any suitable function of the length of the current lane.

When a neighbouring edge in the lane graph 700 is traversed, a cost is incurred that is equal to the distance between the supporting side-lane mid-lines. That is, for a left or right edge, lateral distance is material. For example, the cost of a left or right edge from a current lane to a neighbouring (left or right) lane may be a lateral distance between the current lane and the neighbouring lane. The lateral distance need only be approximate and generally representative of the additional travel distance incurred by a lane change. Indeed, one aim is to prevent a cost-based search of the graph from returning routes with excessive left-right lane changes (e.g. switch back and forth between the same two lanes repeatedly), and to achieve this, any non-zero cost of sufficient magnitude may be used (because each ‘unnecessary’ left/right lane change adds to the overall cost).

The point at which the lateral distance is measured is arbitrary, and one option is to use the maximum of the inter side-lane mid-line distance at the start and the end of the supporting lane-section (to keep it symmetric). In this case, the distance penalty for a left/right edge is taken as the lateral separation between the current lane and the neighbouring lane (or some function thereof) at the start of the current lane or the end of the current lane (whichever is greater). Ideally one might want to use something more representative of any excess arclength introduced by making the lane-change, but the simpler heuristic it is sufficient for the current purposes. In any event, as noted, any lateral distance penalty sufficient to prevent repeated or unnecessary left/right lane changes may be sufficient.

It will be appreciated that distance-based costs can be constructed in other ways, and that the exact choice will be implementation-specific. In the context of a route planning query, distance-based costs need only be generally representative of travel distances associated with lane changes (in the broad sense), with the aim of finding an approximate shortest route (in the geometric sense) between any two given nodes of the graph 700. Other forms of cost may also be defined to support other types of topological query. In this context, although the query and the lane graph 700 are topological in nature, the costs are based on lane geometry. Geometric costs allow geometric information to feed into topological queries without compromising runtime performance.

As noted, one example of a topological query at the SQE API 403 is a route-planning query that provides descriptors 423 of a desired start lane and a desired end lane. In order to respond to this query, a depth-first search is performed, taking into account the edge costs, with the aim of finding the lowest-cost route (lane sequence) from the start lane to the end lane. This will not necessarily be the route with the fewest lane changes; although the query is topological in nature, the costs are based on lane geometry. Although the costs generally discourage lane changes, it is the overall cost that matters. For example, in a road with high curvature, a lane closer to the center of curvature may be materially shorter (longitudinally) than a lane further from it (one concrete example being a roundabout; the innermost lane of a roundabout may be significantly shorter that the outermost lane). In this case, the additional penalty incurred by one or more left or right lane changes may be less the “saving” gained by choosing a shorter lane closer to the center of curvature.

### Road Partition Index

Returning briefly to FIG. 5, OpenDRIVE uses continuous, parameterized mathematical functions to describe road and lane geometry (and road/lane structure more generally). This presents challenges for geometric indexing and efficient querying, as set out below.

At a minimum, a road must have a road reference line that is described by a pair of scalar-valued functions (x(s),y(s)) or, more likely, a set of such function pairs having different supports along the road, as a function of inertial coordinates (x,y). Exactly how this is done depends on the character of the curve. For lines, arcs and spirals the curves are defined implicitly by specifying the characteristic properties of the curve (e.g. the curvature, etc.), but for the parametric cubic curves it is done explicitly. Currently, the available function classes for describing road reference lines in OpenDRIVE are: straight line, spiral, arc, polynomial and parametric polynomial. Polynomials and parametric polynomials can be defined up to third order (cubic). A function can change because the function class changes (e.g. from straight line to spiral), or if the function class does not change but at least one parameter changes (one example being two polynomial functions with different parameters). For example, on some s-coordinate interval s=[0,s1), the road reference line might be described by a first, linear (straight line) function, parameterized by some starting coordinates (x0, y0) at s=0 and a gradient (slope) of the line, ending coordinates (x1, y1) at s=s1. On a subsequent s-interval, [s1, s2), the road reference line might be described by a second, spiral function starting at (x1, y1) in inertial coordinates (s=s1 in road coordinates), continuing to (x2, y2) (s=s2), and described by start and end curvature parameters at s1 and s2. Then, on subsequent interval [s2, s3), the road reference line might be described by a third arc function parameterized by a constant curvature, or some other third function such as a cubic polynomial y=a+bx+cx2+dx3, described by parameters (a, b, c, d) (in fact, OpenDRIVE is more flexible, and allows polynomials to be defined in local (u,v) coordinates, rotated relative to inertial (x,y) coordinates, for describing roads with arbitrary rotation in the world; the following description and the figures refer to polynomials in (x,y) for simplicity, but apply equally to chosen (u,v) coordinates). The intervals [0,s1), [s1,s2), [s2,s3) are the supports (in the mathematical sense) of the first, second and third functions respectively, with s1 and s2 being the points along the road at which the road reference line function changes. Such a change can occur at any arbitrary point along the road.

The above considerations also extend to non-geometric functions. For example, at some point along a marked lane boundary, the form of marking might change (e.g. from a solid line to a broken line). In some implementations, this may be treated (for the purpose of indexing) as a change in lane marking function. In other implementations, non-geometric function may be considered separately; for example, a first road partition index may be constructed for lane geometries and a second road partition index (with different partitioning) may be constructed for some other property or properties of the road/lanes (such as markings, speed limits etc.). In the examples described below, the primary reason for a road partition is to allow the efficient positioning of points either on the lane-boundaries or within the lane itself, and in this context, it may be desirable to consider only those functions describing lane geometry in the road partition index 407. Alternatively or additionally, one might choose to partition the road in different ways to support other tasks that are largely independent from that task (such as computing lane markings or speed limits etc.). Thus, one or multiple road partition indexes may be constructed that are task-specific to varying degrees (each is constructed according to the same principles, but on different function sets, and thus with different partitioning in general as defined by the supports of their respective function sets).

A separate road partition index is generated for every road in a road network. Every road identifier is associated with a “RoadLookups” instance and that instance manages a “RoadPartition” instance. These are all initialised on construction of a ScenarioQueryEngine instance (and are immutable thereafter).

The road partition index 407 of FIG. 2 is structured with the above considerations in mind. OpenDRIVE is considered by way of example, but the road partition index can be usefully applied to road having multiple components (e.g. reference line, center-lane/center-line, lane(s)/side-lane(s)), where each component of the road is described by at least one function that can change along the road, independently of the other component(s) and/or function(s) (at least to a degree). The number and/or nature of the components may or may not also change along the road (e.g. in open drive, the number of components can change as the number of side-lanes can change). As such, there is generally no particular relationship or alignment between the respective supports of those functions, and those supports can overlap more or less arbitrarily with each other. The road partition index 407 may take into account all possible functions that describe a road (e.g. all required geometric function, plus any non-geometric functions such as lane markings etc.) or only a subset of functions (e.g. geometric functions only, or some subset of geometric functions depending on the ultimate application).

The principle of the road partition index 407 is as follows. Given a set of functions under considerations, the road is partitioned such that, within each road part, the subset of functions describing that road part do not change. This means that the number of functions does not change, and the type and the parameters of each of those function(s) remains constant within the road part.

In other words, a road-part is an element of a road-partition, which in turn is a sequence of s-intervals that cover the entire length of the road such that, in each interval, the functional structure of the entire road cross-section remains fixed (with respect to the set of functions under considerations).

### Track Coordinates Query

One type of query which may be run at the SQE API 403 is a track coordinates query. In this case, the query contains a point (x,y) but also a descriptor of a road part containing (x,y). The latter is determined, in practice, by first running a containment query, which is discussed in table 3.

The SQE 402 uses the information in the track coordinates query to locate the corresponding entry in the road partition index 407, retrieves the road reference line function, and computes the geometry of the road reference line for the road part in question. In practice, this is done by finding the closest point to (x,y) on the road reference line within the specified road part S2 (the s-coordinate of (x,y) or its “ds” coordinate, which is then added to s2, the starting s-coordinate of the specified road part S2, to yield the s-coordinate). The s-coordinate of (x,y) is returned in a response along with its t-coordinate, namely the lateral offset between the point (x,y) and its s-coordinate. There is subtlety, in that the closest point to (x,y) on the road reference line might actually lie in another road part if (x,y) is close to one end of the specified road part. In this case, the response provides the closest point to (x,y) at the start or end of the lane section (at s2 or s3 for the road part S2), which is not the exact (s,t) coordinates. This may be explicit or implicit in the response, and is left to the developer to resolve as needed—in some applications, the point at the beginning/end of the road/lane part may be sufficient in these circumstances. In other applications, where the precise coordinates are needed, the developer is free to code an additional road partition query to the API in those circumstances, on the closest adjacent road/lane part instead. In some applications, approximate (s,t) coordinates may be sufficient. If not, the developer can easily obtain the exact (s,t) coordinates by running a second track coordinate query on the same point (x,y) and the closest adjacent lane part to (x,y) (S1 or S3 in this case), and repeating as needed until the actual (s,t) coordinates are found. In an alternative implementation, those same steps could be performed automatically within the SQE 402 in those circumstances, in generating the response to the query. In such implementation, the query on a specified road part (e.g. S2) always returns the actual (s,t) coordinates, even if those (s,t) coordinates lie in a different road part.

Note, the query is answered using the road partition index 407 directly (although, as noted, the road part may be found via an earlier containment query, that uses the box tree 450 in the first phase).

The above techniques for performing a track coordinates query may be useful in context of the SLAT system described later herein. That is, annotations on a map may comprise an annotation coordinate in a local reference frame (i.e., an (s,t) coordinate). Identifying global coordinates that correspond to these local coordinates is key to identifying a corresponding point in a target map, because modelling of road elements may differ between source and target maps, as described in more detail later.

Reference is made back to table 3, which describes other queries which may be implemented by the SQE system.

### Applications

One application of the described techniques is to support a graphical scenario editor, in which a user can “drop” points on a road layout, and automatically generate paths through these points. The API 403 of the SQE 402 can be used to support the graphical interface, using the queries described above. For example, International Patent Application No. PCT/EP2021/064283, the entire contents of which is incorporated herein by reference, disclosed a graphical scenario editor tool for creating/editing scenarios for use in simulation. A user marks locations on a graphical representation of the road, which are used to generate a path automatically. The SQE 402 can be used to support such a tool via structured queries to the API 403 that are generated responsive to GUI inputs.

Another application is roundabout detection. Roundabouts may be identified by identifying one-way loops in graphs of roads, from the lane graph representation 700. An additional query mode to find any one way loops—or, more generally, isomorphic subgraphs of the lane graph 700—can be provided for this purpose. A slight ‘coarsening’ of the directed lane graph may be used to detect roundabouts in which only the road links are retained. The system looks specifically for loops in the directed road graph that begin in the connecting road of junctions and are solely composed of one-sided roads with only left or right lanes. All of the lanes in the connected loop that forms the roundabout itself will support traffic flow in the same compatible direction.

In a simulation context, the SQE 402 can support a scenario simulator, and in a run-time context it can support planning/predictions functions within the stack 100.

An alternative to the SQE 402 described above approach would be to run such queries on the static layer 412 (OpenDRIVE document) directly, via a lightweight view of the original document. However, the current OpenDRIVE format (v1.6.1) is too implicit a description of the road network to do this efficiently.

Instead, the geometric and topological indexes 409, 411 provide geometric and topological “views” of the document 414 (in the formal database sense).

The indexes 409, 411 are immutable, in that they are derived once from the static layer 414 and not varied.

An additional use of the SQE system provides a system for importing annotations from a source map (or graph) into a target graph. The material that follows describes this system in more detail.

### Overview of the Annotation Importation Functionality

The present application relates to a “Static Layer Annotation Tool”, or “SLAT” system, which is configured to automatically transfer one or more annotations in a first static layer or map to a second map that represents a same location; i.e., a second version of the first map which does not comprise the one or more annotation. The SLAT system performs a novel method, described later herein, to identify a correct road structure ID in the second version of the map, which lies at a coordinate corresponding to an annotation in the first map, and to encode the one or more annotation in the second map layer at corresponding coordinates.

It will be noted that the terms “source” and “target” static layer merely indicate a direction of importation. That is, the term “source” static layer refers to a static layer or map in which one or more static feature is to be identified for importation. The term “target” static layer refers to a static layer into which a feature (identified in a source static layer) may be encoded, based on identification of a correct road structure in the target map, to which the annotation in the source layer should be transferred.

Reference is now made to FIG. 8, which shows an exemplary road network 160 comprising a plurality of road structure elements 162 that are linked such that vehicles may travel down one of a plurality of routes within the road network. Each road structure element 162 is shown with a direction indicator 166 that indicates a direction of flow of traffic along the associated road structure element 162. It will be noted that the exemplary road network 160 of FIG. 8 may be described by a graph database or other data structure that represents a “static layer”; for example, one defined using OpenDRIVE.

In the example of FIG. 8, certain road structure elements 162 overlap or intersect to form the plurality of routes in the network. Shading has been applied to the road network 160 such that regions comprising an increasing number of overlapping road structure elements are represented by a darker shade of grey.

For the reader's ease in identifying the plurality of routes that may be taken by a vehicle within the road network 160, reference is made to FIG. 8a which shows six instances 160a-160f of the road network 160, each instance highlighting a route that may be taken within the road network 160.

It will be noted that the connections from one road structure element to a next element in a path are also defined in a road graph or static layer. Therefore, sequences of road structure elements defining separate routes or paths through a road network are encoded into the static layer. Where there are multiple onward directions from a particular road element, i.e., two routes no longer share a common road structure element, that particular road element is associated with multiple onward connections. In such a case, each onward connection will identify a distinct, next road structure element for each onward path/route.

Returning to FIG. 8, the road network 160 is shown to comprise three yield points 164a-164c, which indicate respective locations on particular road structure elements 162 at which a vehicle may be required to stop in order to take a particular route. In the example of FIG. 8, yield point 164a may be relevant to vehicles taking a route corresponding to instance 160f of FIG. 8a. Similarly, yield points 164b and 164c may be relevant to vehicles taking routes respectively corresponding to instances 160b and 160e of FIG. 8a. Yield points are encoded as annotations in a static layer, and are associated with road structure elements themselves. That is, in instances where a yield point is located at a coordinate where multiple road elements overlap, e.g., different paths cross over each other, that yield point is associated with only one of the overlapping road structure elements, and therefore only associated with one of the multiple paths.

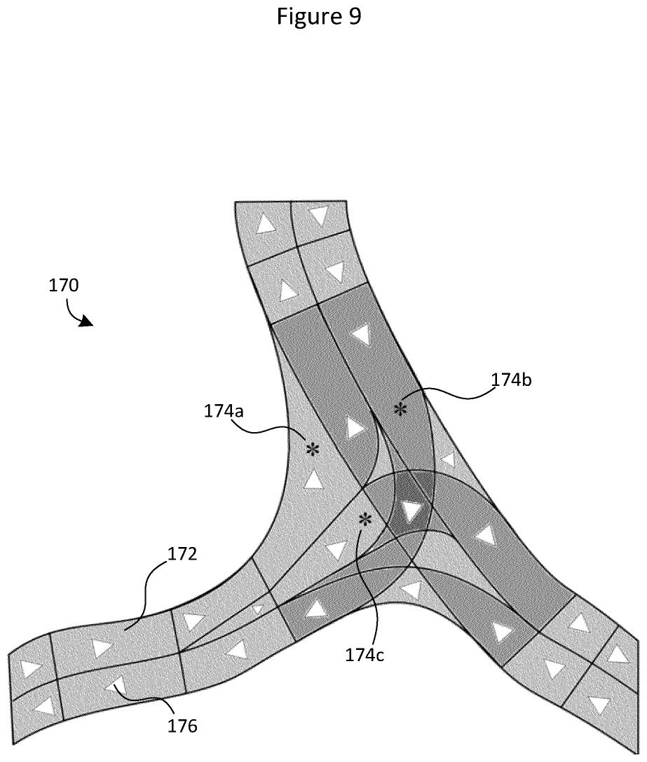

FIG. 9 shows a second exemplary road network 170 comprising a second plurality of road structure elements 172 which, similar to FIG. 8, are linked by road ‘connections’ encoded in the static layer, such that vehicles may travel down one of a plurality of routes within the road network 170. Each route may represent a distinct sequence of road structure elements, where successive elements in the sequence are defined by the ‘connection’ structures of the static layer. Like the example of FIG. 8, certain road structure elements 172 in FIG. 9 overlap or intersect to form the plurality of routes in the network 170. Again, shading has been applied to the road network 170 such that regions comprising an increasing number of overlapping road structure elements are represented by a darker shade of grey.

FIG. 9a shows six instances 170a-170f of the road network 170, each instance highlighting a route that may be taken within the road network 170.

FIG. 9 further shows three yield points 174a-174c. In the example of FIG. 9, yield point 174a may be relevant to vehicles taking a route corresponding to instance 170f of FIG. 9a. Similarly, yield points 174b and 174c may be relevant to vehicles taking routes respectively corresponding to instances 170b and 170e of FIG. 9a.

Road network 160 of FIG. 8 and road network 170 of FIG. 9 represent a common road network. That is, the road elements of each network 160, 170 are configured to represent the same overall static driving scene. Whilst both road networks 160, 170 are geometrically very similar, some variation may be seen in road structure element shapes, in the locations of links between road structure elements, in the locations at which reference lines for roads begin and end, and in the way that road structure elements are configured to represent junctions in the two road networks 160, 170. Furthermore, precise road IDs may differ between the two maps. Therefore, a method for automatically transferring annotations from a source map to a target map must operate independently of road IDs, locations of links between roads, and of any other feature that is specific to the precise way the road elements in the source map are modelled.

The presently described SLAT system is configured to implement such a method for importing annotations or static layer features from a source static layer to a congruent target static layer. For example, consider that the road layout 170 of FIG. 9 were not provided with the yield points 174a-174c, but that the yield points 164a-164c of FIG. 8 are to be imported into the road network 170 of FIG. 9. In this example, a first static layer representing road network 160 would be a source static layer, and a second static layer representing road network 170 would be a target static layer. The SLAT system described herein may be capable of identifying an annotation coordinate of an annotation in the source map that is to be transferred, identifying one or more road structure element in the target map that comprises some region of intersection with the road element in the source map that comprises the annotation, disambiguating the identified elements in the target map where a plurality is found, and encoding the annotation in the correct road structure element of the target map at the annotation coordinate.

It will be noted that differences in form of road structure elements between two otherwise congruent road networks may arise due to differences in modelling the shape of a road. That is, geometry of a road's reference line may be mathematically described by separating the reference line into one or more segment, wherein the form of each segment is modelled by a particular type of line or curve. In OpenDRIVE, a linear function or curve, such as a spiral or clothoid (with linearly changing curvature), an arc with constant curvature, a cubic polynomial, or a parametric cubic polynomial may be used to model the form of a segment of a road's reference line. A plurality of segments may connect end-to-end to define an overall road reference line. Each segment, defined by a line or curve according to one of the above models, may form a road structure element, which may be linked in the graph database of the static layer to form the road reference line. Two static layers describing the same static driving scene may model different sections of a road differently (i.e., using different mathematical curve models), arising in differently segmented roads which are nonetheless substantially the same, geometrically. Alternatively, target maps may differ in form to source maps if the target map represents an updated version of a driving scene represented by the source map and some intermediate change in form, such as building a new road, has occurred since the source map was created.

FIGS. 8 and 9 represent only a small road network, one which is only shown to include three annotations, e.g., the yield points 164a-16c or 174a-174c of FIGS. 8 and 9 respectively. Nevertheless, significant manual effort may be required to manually transfer annotations from static layer 160 to static layer 170 by configuring identical annotations to those of FIG. 8 in the road layout of FIG. 9. With that manual effort comes an increased likelihood for human error when transferring annotations. Both the extent of manual effort and the likelihood of human error scale with the number of annotations in a static layer. Therefore, transferring annotations between much larger static layers, comprising many more annotations, may represent a huge manual task unless a competent automated system were capable of copying source annotations into a target static layer. The present invention is directed, at least in part, to addressing these concerns. Users of the annotation tool described herein may receive a map from a map provider, and add additional annotations to it for their specific needs, which takes time. In one example, yield points may be added so that simulated vehicles know when to stop (e.g. they know to stop and yield when turning right at a certain junction). A new version of the map from the map provider may then be received, and rather than repeat the costly process of adding the additional annotations to the new version of the map, the tool enables the user to use the work already done on the previous version by transferring the annotations.

The yield point denoted 174b in FIG. 9 best exemplifies the need for the disambiguation process. The shading on the road at yield point 174b indicates that more than one road element overlaps at that point. It is therefore necessary to select a correct one of the spatially overlapping elements for assigning the annotation. Where an annotation is configured in respect of a signal, which has ‘lane validity’ annotated on it, i.e., an annotation that specifies one or more lane to which the signal applies, the midpoint of each of the lanes to which the signal applies in the source map may be identified, and the system may find the IDs of the lanes at these positions in the target map in, the appropriate target road element that has been already determined.

### Disambiguation for Annotation

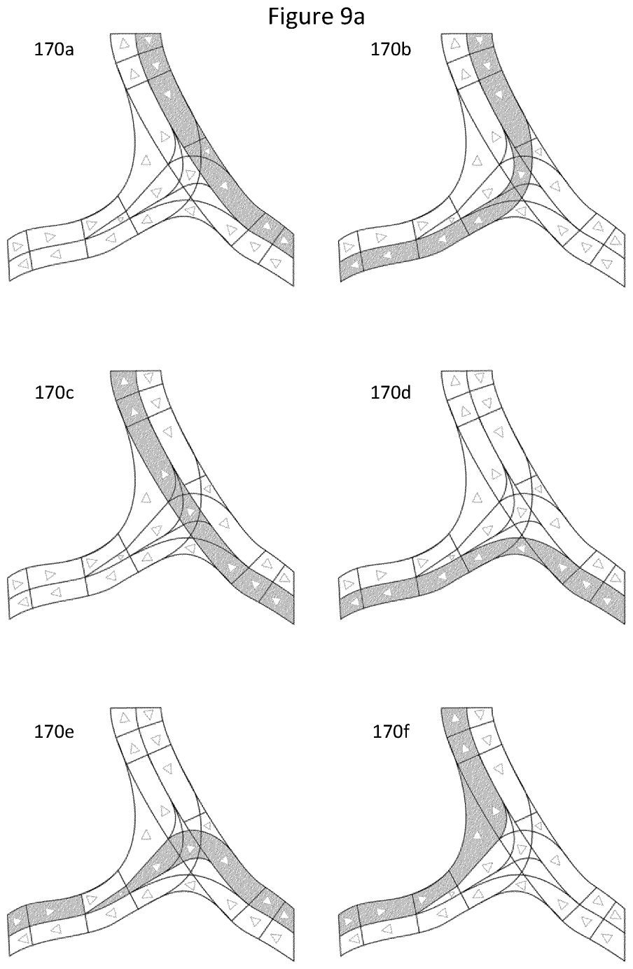

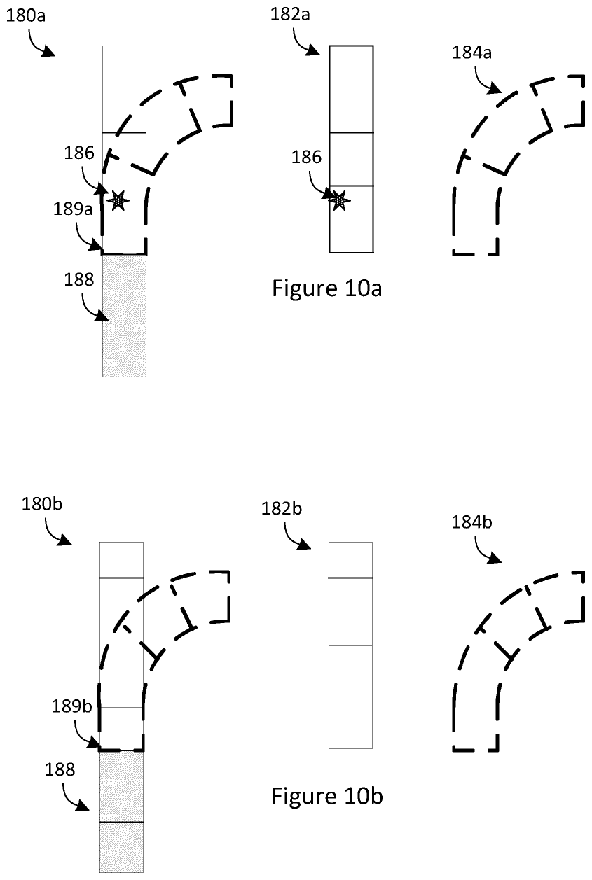

FIG. 10a shows a first exemplary map 180a. The first map 180a is separable into two distinct ‘sequences’ 182a, 184a of road structure elements. That is, starting from a first road element, a first sequence 182a of connections forms a first path, and a second sequence 184a of connections forms a second path. In the first exemplary map, both paths comprise two common road structure elements, as represented by the shaded region 188. However, the upper extreme of the shaded region 188 represents a road element boundary with two distinct onward paths that can be taken. That is, the road structure element denoted 189a comprises two connection structures, one to a first onward road structure element unique to a first of the onward paths, and another connection to a second onward road element unique to a second onward path. In the first map, the road elements unique to the second onward path are represented by bold dashed lines.

For clarity, road elements that are respectively unique to the first and second sequences 182a, 184a are shown separately under the combined first map 180a.

The first map 180a further comprises a first annotation 186 which, as demonstrated by the separated view of the two paths, is associated with a road structure element that is unique to the first onward path. That is, whilst the annotation 186 is located at a point in the map 180a where the first and second paths are seen to overlap, the annotation is in fact associated with the first path (along first sequence 182a), and any driving instruction or other indication associated with the annotation 186 is not relevant to vehicles which take a path along the second sequence of road elements, corresponding to the second path.

FIG. 10b shows a second exemplary map 180b, which represents a same driving scene as in FIG. 10a. Road elements that are unique to first and second sequences 182b, 184b of the second map 180b are shown separated under the combined second map. It will be noted that the modelling of road structure elements in the second map 180b of FIG. 10b is different to that of FIG. 10a, and that the annotation 186 in FIG. 10a is not present in the second map 180b.

An annotation coordinate of the annotation 186 in FIG. 10a may be used to identify a corresponding location in the second map 180b. This is because the two maps 180a, 180b represent a same driving scene and may be geometrically similar or congruent in a global coordinate system, even if the local modelling of road elements in each map is different. However, it is not a simple task to correctly assign a corresponding annotation 186 in the second map, and a consistent and robust method of annotation transfer cannot be made by merely considering the annotation coordinate in the first map and finding a corresponding coordinate in the second map, as is now described. It will be noted that the first map 180a may be considered a source map, and the second map 180b may be considered a target map. For the purposes of the description later herein, the sequence of road elements in FIG. 10a comprising the annotation 186 may be considered a source sequence.

In addition to providing the annotation at a corresponding coordinate, it is also important to assign the annotation to a corresponding road structure element in the second map, such that the annotation is associated with a correct path in the road network. This is because, as indicated above, annotations may in practice define a road instruction or otherwise provide information to a driver (e.g., a signal), and those instructions may apply only to drivers on certain paths in the road network, even if those paths have some area of overlap with another path at the location of the annotation. With reference again to FIGS. 10a and 10b, if an AV (or a non-ego agent in simulation, which is much simpler than a full AV, as it has all the ground truth of the simulation available to it) is placed at that point where the annotation 186 is located-a point where multiple road sequences/routes overlap- and where the annotation 186 represents a signal, that AV or non-ego agent may have received explicit instructions (e.g., ‘follow this specific route’) that allow it to know which of the map's overlapping road elements it is really ‘on’. As such, the vehicle can pay attention to the annotations (e.g., ‘yield here’) on that road element (and on the rest of the route comprising that element) and can ignore other signals in elements that it is not on, or in routes which it is not taking. It is in such use cases, where an agent has knowledge of which road element they are ‘on’, that effective implementation of the disambiguation process is particularly salient.

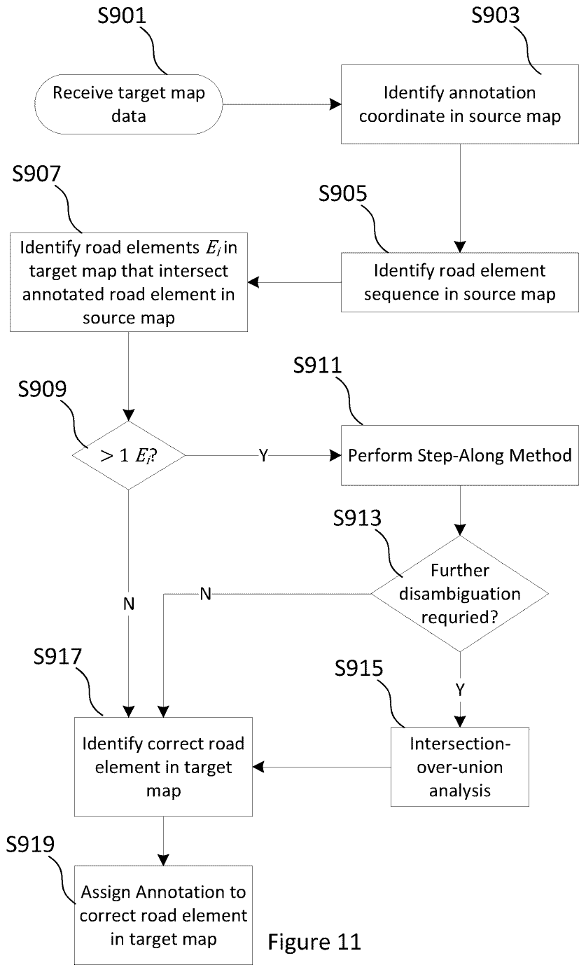

In examples where multiple road structure elements comprise some region of intersection with the road element in the source map that comprises the annotation, some method of disambiguation must therefore be performed to ensure that the road element to which the annotation is assigned in the second map indeed lies on an equivalent path in the road network of the second map. This method of disambiguation cannot rely on annotation coordinate alone, and cannot depend on road element IDs, or any other parameter that is only locally applicable in either the first or second map. Such a method is now described with reference to FIG. 11. Though not shown in FIG. 11, additional pre-processing steps for disambiguation may be conducted. For example, in some embodiments, candidate road elements in the target map may be excluded (disambiguated) based on a heading of the road, e.g., a direction of flow of traffic compared to the source road element from which the annotation is transferred.

### Annotation Transfer Method

When an annotation in a source map is identified for transfer to a target map, there are several known factors which may form the basis of a transfer method; these include:
a. An annotation coordinate of the annotation in a global (world) coordinate system;
b. A road element in the source map with which the annotation is associated;
c. A sequence of one or more road element that includes the road element in point b. above; and
d. The source and target maps represent a common static scene.

A first step in the annotation transfer process may be to identify the annotation coordinate of a., and the road element in b. above. A next step may be to identify any other road element that forms the sequence of c. above. This sequence may be defined as a set of interconnected road elements through which only one route may be taken. That is, the sequence may begin at the road element of b. above, and continue in both directions along the road until there are multiple onward directions; i.e., until the road elements at either end comprise two connection structures, from which multiple paths extend. The set of road elements forming the single path between the two endpoints may form the sequence of c. Note that the sequence may be of arbitrary length, but may also include only the road element of b. in situations where multiple paths converge and connect into that road element, and where that road element immediately leads immediately into a further plurality of onward paths.

The above steps are represented in FIG. 11 by steps S901-S905. FIG. 11 is a flowchart that represents an exemplary process for automatically transferring annotations from a first (source) static layer to a second (target) static layer. Step S901 represents a step of receiving target map data, to which one or more annotation of a source map is to be transferred. Step S903 of FIG. 11 comprises identifying an annotation coordinate of an annotation that is to be transferred, and step S905 comprises identifying a sequence of road elements in the source map that comprises the road structure to which the annotation is assigned, As described above.

Before the annotation transfer can be made, a correct road element in a target map must be identified. The correct road element in the target map (herein, ‘target road element’) must satisfy the conditions that;
i. The target road element comprises some region of intersection with the road element in the source map that comprises the annotation; and
ii. The target road element must form part of a sequence of road elements in the target map that optimally overlaps the identified sequence of road elements in the source map (i.e., the sequence comprising the annotated road element in the source map).

A next step S907 of FIG. 11 comprises identifying any road elements in the target map that comprise some region of intersection with the road element in the source map that comprises the annotation.

A determination is made in a next step S909, as to whether more than one such road element has been identified in the target map. If it is determined that only one such road element has been found in the target graph, the flow progresses to a step S917, wherein that one road element is identified as the correct target road element. The flow may then progress to a step S919, wherein an automatic assignment of annotation data to the target road element is performed. The annotation data may comprise the annotation coordinate and/or any other annotation feature defined in the source map. That is, the annotation data may be copied and assigned to the target road element.

Moreover, in examples where there is only one road element in the target map that comprises some region of intersection with the road element in the source map that comprises the annotation, the condition in ii. above may be overlooked. In such cases, annotation data equivalent to that in the source map may be encoded in the target map, by assigning the data to a road structure in the target graph that represents the one road element of the target map that comprises some region of intersection with the road element in the source map that comprises the annotation.

In other examples, where a plurality of road structure elements in the target map comprises some region of intersection with the road element in the source map that comprises the annotation, a method of disambiguation referred to herein as the, ‘step-along’ method may be implemented to identify a correct road element in the target map, to which the annotation is later assigned. That is, if step S909 returns TRUE, the flow progresses to a step S911, which comprises a ‘step-along’ method for disambiguating the plurality of identified road elements in the second map. The step-along method is described in more detail later.

Next, at a step S913, a determination is made as to whether any further disambiguation is required. If this step returns TRUE, this may indicate that two or more of the plurality of identified road elements cannot be separated by the ‘step-along’ method, and the flow progresses to a step S915, wherein an intersection-over-union analysis is performed to further disambiguate the road elements. The intersection-over-union analysis of step S915 is described in more detail later herein.

Step S915 then continues to step S917 and then step S919, which are described above.

### The Step-Along Method

The step-along method of step S911 in FIG. 11 is now described in more detail. The step-along method is performed when multiple road elements in the target map comprise some region of intersection with the road element in the source map that comprises the annotation; these road elements are referred to herein as ‘candidate target road elements’. As a preliminary step, a respective sequence of road elements in the target graph may be identified for each candidate target road element. A candidate sequence for each candidate element may be identified according to the same process as described in respect of the sequence in the source map, essentially identifying a set of road elements that are unique to a particular path. The step-along method assesses overlap between the sequence of road elements in the source map that comprises the annotated element, and the respective sequence of road elements for each candidate target road element in the target map.

The step-along method involves taking either: a step along the sequence in the source map, a step along a candidate sequence in the target map, or both of the above. Each time a step is taken, an assessment is made as to whether there exists a region of spatial overlap between a swept area of the step taken along the path(s), or not. Each step may move to a next road element boundary in the sequence, and the process may terminate either when no step that results in new overlap can be taken, or when both sequences have been iterated over. If the process terminates by iterating over all road elements in both sequences, it may be determined that the candidate sequence passes the step-along test, and the corresponding candidate target road element may remain a candidate element. If, instead, the process terminates because no next step can be taken that results in further overlap, the candidate sequence may be considered to fail the step-along test, and the corresponding candidate road element may no longer be considered a candidate. Note that in many examples, the source map sequence and/or a candidate sequence may extend in both directions from the annotation coordinate, and the steps above may therefore be carried out in both directions along the sequences, either in parallel, or in one direction, and then another once the end of a sequence is reached in the first direction. In some embodiments, failure to find a step that results in further overlap may cause the entire process to terminate, even if a second direction along the two sequences has not been tested yet. That is, in such an embodiment, the only termination criterion that results in iterating in the second direction along the sequences is when the end of a sequence is successfully reached in a first direction.

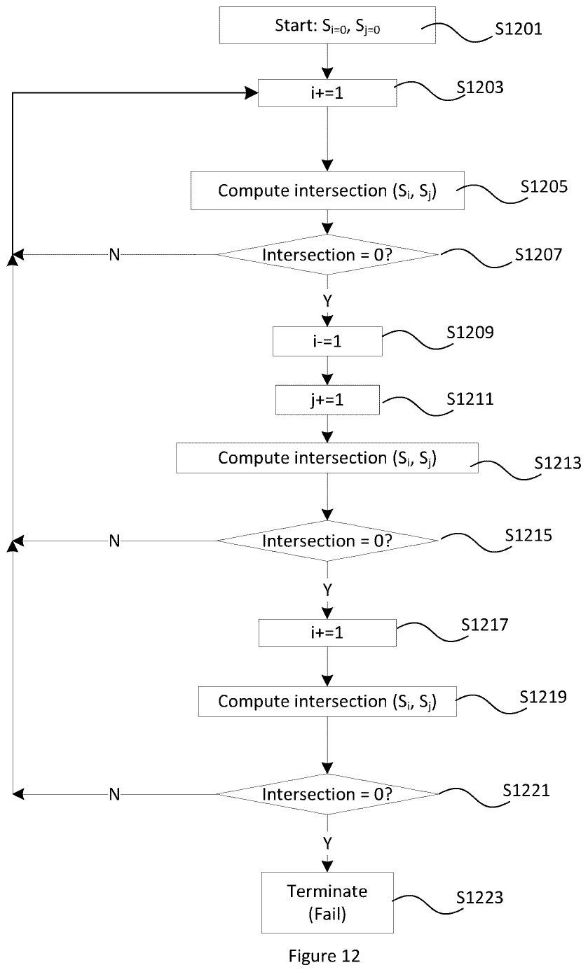

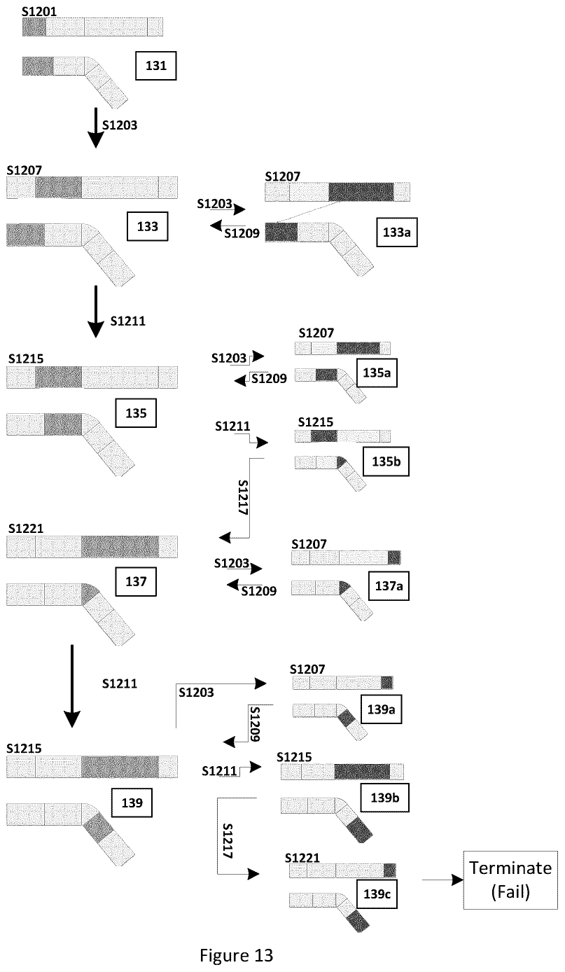

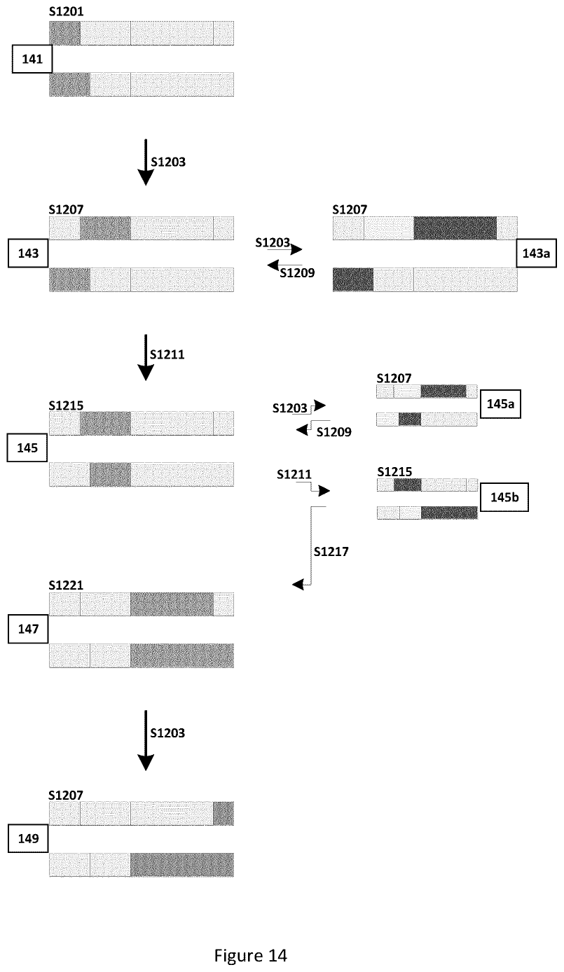

An embodiment of the above method is now described with reference to FIGS. 12, 13 and 14. FIG. 12 shows a flowchart that illustrates exemplary steps of the step-along method. FIG. 13 represents the process of FIG. 12, as applied to a candidate sequence that does not match the source road sequence. FIG. 14 represents the process of FIG. 12, as applied to a candidate sequence that does match the source road sequence.

The flowchart of FIG. 12 begins at a step S1201, wherein the source road element in the source sequence and a first candidate element of a candidate target sequence are selected. It may be taken as known that the starting elements overlap because a candidate target road element may only be identified as such if it has some region of spatial overlap with the source road element. FIG. 12 refers to parameters i, j, which respectively refer to an index of road elements on the source and target road sequences. For example, the notation, ‘St’ refers to a road element in the source sequence with index i.

At a next step S1203, index i is incremented, such that a next road element in the source sequence is selected.

At a next step S1205, intersection between road elements of current index i, j is computed.

If it is determined, at a step S1207, that the intersection computed in step S1205 is non-zero, the flow returns to step S1203 above, wherein index i is incremented again. This check for intersection (step S1205) is done every time any increment is made to i or j. Whenever the intersection is calculated, the method returns to step S1203 if the intersection is non-zero.

If it is determined that there is no intersection at Step S1207, the increment in i (done at step S1203) is undone by decrementing i at a step S1209. Next, index j is incremented instead. That is, after determining that there is no region of overlap when stepping along the source sequence, the method includes stepping along the target road element sequence instead. At a step S1213, intersection is computed again between Sᵢ and Sⱼ. If the intersection is determined non-zero, at a next step S1215, the flow returns to step S1203.

If intersection is determined to be zero at step S1215, i.e., after trying to step along the source and target sequences separately and finding that both give zero intersection, the method includes stepping along both road sequences at the same time (computing intersection with both i and j incremented). This is to check for edge cases where road elements in both maps end at the same point.

Therefore, if it is determined at step S1215 that the intersection is zero, index i is incremented again in a step S1217 (such that both i and j are incremented). Intersection is computed at a next step S1219. If it is determined at a next step S1221 that there is no intersection, it may be inferred that there is no such edge case, and the process is terminated at a step S1223, because the road sequences spatially diverge and no longer overlap. If there is determined to be a region of overlap at step S1221, the flow follows as normal and goes back to S1203. This only happens in the above edge case.

The flowchart of FIG. 12 does not show termination of the process due to the sequences passing, i.e., an example where the end of a sequence is reached without failing to find a region of overlap. However, FIG. 14 does represent this situation in the bottom drawing. Termination due to passing may occur when, for example, there is no single onward road element in the target or source sequence (i.e., there are multiple onward routes in either sequence), or after a predetermined number of elements have been assessed.

It will be noted that the sequence of road elements (target or source) to which the indices i, j are assigned is entirely trivial, and is a matter of convention. That is, after each determination that there is a region of overlap, the system could step along either road sequence next, by convention, and arrive at the same conclusion.

The step of computing whether there exists a region of intersection between road elements Sᵢ and Sⱼ may be implemented using containment queries, as described previously herein.

### Further Disambiguation|Intersection-Over-Union

If, after performing the above step-along process for all candidate sequences (corresponding to all candidate target road elements in the target graph, as identified in step S907 in FIG. 11), there remains a plurality of candidate target road elements, a further disambiguating step may be conducted. The further step may comprise calculating an intersection-over-union (IOU) ratio for each candidate sequence against the source map. The candidate road element corresponding to the candidate sequence which is calculated as having the highest IOU ratio may be selected as the target road element to which the annotation is assigned in the target map.

Those skilled in the art will appreciate that an intersection over union operation for first and second regions outputs a ratio of the area of intersection (or overlap) between the first and second test regions, and an overall area of the two test regions. That is, for test regions A and B, intersection over union J(A, B) is defined as:

$$J ( A , B ) = \frac{\vert A ⋂ B \vert}{\vert A ⋃ B \vert} .$$

It will be appreciated that whilst the above method is conducted in respect of sequences of road elements, not lanes therein, the disambiguation process of calculating intersection over union may be applied in respect of particular lanes in examples where a static feature intended for importation is encoded in respect of a particular lane of the road. Some road markings, for example, are encoded with respect to lanes.

### Examples of Application of ‘Step-Along Method

Reference is now made to FIGS. 13 and 14, which illustrate two exemplary applications of the step-along method shown in FIG. 12. FIGS. 13 and 14 represent first and second applications of the method for disambiguating two candidate sequences. The exemplary candidate sequences of FIGS. 13 and 14 may correspond to the exemplary paths of the target map in FIG. 10b. The exemplary source sequence of FIG. 13 corresponds to a sequence that includes path 182a of FIG. 10a, which comprises the annotation 186. That is, in FIG. 10b, there are two candidate target road elements which comprise some region of intersection with the road element in the source map that comprises the annotation 186 in FIG. 10, each associated with a target sequence. The two sequences 182b, 184b shown beneath the target map 180b in FIG. 10b respectively correspond to the target sequences in FIGS. 13 and 14, though road element boundaries in each sequence differ between the figures for illustrative purposes. The method is applied to assess which candidate sequence maps onto the source sequence, so that a correct target road element may be identified. FIGS. 13 and 14 each include a plurality of representations of the source and target sequences. Road elements under test (for intersection) in each sequence are highlighted in each representation. Arrows are shown between representations, each arrow labelled with a step as denoted in FIG. 12, indicating what part of the step along method is taken between each representation. Other than the first representation, labelled S1201, each representation in FIGS. 13 and 14 is labelled with either step S1207, S1215, or S1221, indicating which of the intersection determinations steps of FIG. 12 is being conducted at each representation.

Starting at the top of FIG. 13, a first representation (rep.) 131 exemplifies step S1201. Stepping downwards along an arrow labelled S1203, a step along the source sequence (the upper sequence in each representation) is taken to reach a next representation, rep. 133, where step S1207 is taken to determine intersection. There is overlap between the two road elements under test in rep. 133, so step S1203 is taken, stepping to the right to reach rep. 133a, in which there is no overlap. Therefore, step S1209 is taken, undoing the step along the source sequence. Step S1211 is then taken, moving along the target sequence to rep. 135, where overlap is found in step S1215.

From rep. 135, step S1203 is taken to reach rep 135a, where no overlap is found. The step along the source sequence is undone at S1209, then the target sequence is stepped along instead at step S1211, reaching rep. 135b, where still no overlap is identified. Step S1217 is taken to reach rep. 137. Note that step S1217 is done to identify edge cases where road element boundaries are in the same place. As confirmed by the identification of a region of overlap at step S1221 in rep. 137, and as may be seen in FIG. 13, both elements under test at rep. 137 start at the same place. This is an example of the above-described edge case.

From rep. 137, step S1203 is taken to reach rep 137a, where no intersection is found when taking step S1207. Steps S1209 and S1211 are taken to reach rep. 139, wherein step S1215 returns that there is a region of intersection between the road elements currently under test. Therefore, in accordance with the flowchart of FIG. 12, step S1203 is taken to reach rep. 139a, where step S1207 identifies no region of overlap. Steps S1209 and S1211 follow, leading to rep. 139b, in which still no region of overlap is seen at step S1215. Step S1217 is then taken to check for the above-described edge case, reaching rep. 139c. Step S1221 reveals that there is no intersection between the elements under test in rep. 139c. Therefore, in accordance with FIG. 12, the process is terminated at step S1223, as the candidate road sequence does not match the source sequence.

With reference now to FIG. 14, a first representation (rep.) 141 exemplifies step S1201, where the source sequence is now compared to a second candidate sequence. Stepping downwards along an arrow labelled S1203, a step along the source sequence (the upper sequence in each rep.) is taken to reach a next representation, rep. 143, where step S1207 is taken to determine intersection. There is overlap between the two road elements under test in rep. 143, so step S1203 is taken, stepping to the right to reach rep. 143a, in which no overlap is found at step S1207. Therefore, step S1209 is taken, undoing the step along the source sequence. Step S1211 is then taken, moving along the target sequence to rep. 145, where overlap is found in step S1215.

From rep. 145, step S1203 is taken to reach rep 135a, where no overlap is found at step S1207. The step along the source sequence is undone at S1209, then the target sequence is stepped along instead, at step S1211, reaching rep. 145b, where still no overlap is identified. Step S1217 is taken to reach rep. 147. Again, note that step S1217 is taken to identify edge cases where road element boundaries are in the same place. As confirmed by the identification of a region of overlap at step S1221 in rep. 147, and as may be seen in FIG. 13, both elements under test at rep. 147 start at the same place. This is an example of the above-described edge case.

From rep. 147, step S1203 is taken to reach rep 149, where intersection is found when taking step S1207. In the example of FIG. 14, the process is terminated because all road elements in each sequence have been iterated over. The candidate road sequence of FIG. 14 may therefore remain a candidate sequence for any further disambiguation, if any is required e.g., by intersection over union analysis as described above.

### Relevant Static Features for Importation

The techniques described above may be applied to many different types of static feature. The description that follows outlines several exemplary static feature types to which the which above-described importation techniques may be applied.

A first type of static feature which may be imported according to the above-described techniques is yield points. Yield points may be represented by custom data structures, and may be invisible in a rendering of the static layer, but may be used to indicate instructions for non-ego agents, or to AVs that can ‘see’ the yield points. That is, the yield points may be identifiable to particular agents in a simulation, but may not have a graphical representation in a rendering of a static scene.

Road marking may also be annotated. Some road markings may be encoded using a <road mark> element. The <road mark> data structure enables markings which follow a road reference line to be configured and allows locations, styles, and other attributes of such lines to be encoded. The <road mark> element is for configuring road markings such as road border lines (double yellow lines, e.g.) or lane borders, and may be solid or constituted by a plurality of broken lines that repeat along the reference line of the road. Other attributes such as instructions or road rules that apply in the vicinity of a road marking may be configurable.

Irregular road markings which cannot be described by continuous or repetitive line patterns may be described by individual road marking elements, which may be represented by <explicit> sub-elements within the <road mark> element.

Road marks for objects like crossings, and parking spaces may be encoded using a <markings> element within a higher order <object> element.

Road signals may also be subject to the importation techniques described herein. Generally, the static properties of signals such as road signs may be defined using a <signal> data structure, supported by the OpenDRIVE schema. Signals may be placed in relation to a specific road by encoding a position relative to a coordinate along the specific road. The position of the signal may be described relative to the road reference line, using the s- and t-coordinates. Physical attributes such as height and width of a signal may also be encoded. A type of signal may be defined from a list of possible types. Signal types may be grouped by country, since different countries use different signs, and a particular signal may be defined in the <signal> data structure by populating one or more of a “country” field, a “type” field, and a “sub-type” field in the data structure to encode a predefined signal type into the static layer. The <signal> data structure may further comprise a “dynamic?” field, which may take a Boolean value to indicate whether the signal requires configuration of dynamic behaviour in the dynamic layer, or whether the signal is static.

In addition to importing one or more <signal> data structure into the target static layer, the SLAT system may be further capable of importing other signal-related data structures from the host static layer. For example, the SLAT system may be configured to import <controller> data structures, which may serve as a wrapper for the behaviour of a group of signals, or <dependency> data structures, which enable the state of one or more dependent signal to be defined as a function of a primary signal.

Note that a <dependency> element enables the state of a primary signal to control the output of one or more dependent signal. It will be appreciated that whilst a relationship between the signals may be defined using OpenDRIVE, the actual state of the primary signal (and therefore the dependent signal(s)) may be defined separately in the dynamic layer; e.g., using OpenSCENARIO.

A<controller> element defines a link between a plurality of dynamic signals, such that all dynamic signals linked under a <controller> data structure display an identical state.

References herein to components, functions, modules and the like, denote functional components of a computer system which may be implemented at the hardware level in various ways. A computer system comprises execution hardware which may be configured to execute the method/algorithmic steps disclosed herein and/or to implement a model trained using the present techniques. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include field programmable gate arrays (FPGAs) having a circuit configuration programmable through circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like). The subsystems 102-108 of the runtime stack FIG. 1A may be implemented in programmable or dedicated processor(s), or a combination of both, on-board a vehicle or in an off-board computer system in the context of testing and the like. The various components of FIG. 2, such as the simulator 202 and the test oracle 252 may be similarly implemented in programmable and/or dedicated hardware.

### REFERENCES

Reference is made hereinabove to the following, each of which is incorporated herein by reference in its entirety:
[1] ASAM OpenDRIVE V1.6.1 (and accompanying User Guide), Release Date 4 Mar. 2021 [available at https://www.asam.net/standards/detail/opendrive/].

1. A computer-implemented method of automatically annotating a second road layout map using first annotation data for annotating a first road layout map, the method comprising:
identifying in the first road layout map a source piece of road structure associated with a first piece of annotation data;
matching the source piece of road structure with a target piece of road structure exhibited in the second road layout map; and
generating, using the first piece of annotation data, a second piece of annotation data for annotating the target piece of road structure exhibited in the second road layout map.

2. The method of claim 1, wherein the step of matching the source piece of road structure with the target piece of road structure comprises:
identifying a source sequence comprising multiple pieces road structure in the first road layout map including the source piece of road structure;
identifying two or more candidate pieces of road structure in the second road layout map based on identifying a region of spatial overlap between each candidate piece of road structure and the source piece of road structure;
for each candidate piece of road structure, identifying a corresponding candidate sequence comprising multiple pieces of road structure including that candidate piece of road structure; and
identifying a matching candidate sequence by comparing the source sequence with the corresponding candidate sequence for each candidate piece of road structure, the target piece of road structure selected as the candidate piece of road structure belonging to the matching candidate sequence.

3. The method of claim 2, wherein the source sequence extends from the source piece of road structure at an initial sequence position, and for each candidate piece of road structure, the corresponding candidate sequence extends from the candidate piece of road structure at an initial sequence position;
wherein the matching candidate sequence is identified by iteratively comparing the corresponding candidate sequence with the source sequence for each candidate piece of road structure by:
calculating an intersection between the pieces of road structure at, respectively, the initial sequence position of a first of those sequences and a next sequence position of a second of those sequences, and
if a non-zero intersection is calculated, repeatedly incrementing the sequence position of the second sequence whilst maintaining the sequence position of the first sequence and calculating an intersection between those sequence positions until a zero intersection is calculated or a final sequence position of the second sequence is reached, and
if a zero intersection is calculated, decrementing the sequence position of the second sequence and repeatedly incrementing the sequence position of the first sequence, and calculating an intersection between those sequence positions until a zero intersection is calculated or a final sequence position of the first sequence is reached,
wherein a candidate sequence is determined to match the source sequence responsive to calculating a non-zero intersection at a final sequence position of either of those sequences, the target piece of road structure selected as the candidate piece of road structure belonging to the matching candidate sequence.

4. The method of claim 3, wherein if:
a zero intersection is calculated for a sequence position of the first sequence and a sequence position of the second sequence,
the sequence position of the second sequence is decremented,
the sequence position of the first sequence is incremented, and non-zero intersection is calculated, the method further comprises:
repeatedly incrementing the sequence position of the second sequence whilst maintaining the sequence position of the first sequence and calculating an intersection between those sequence positions until a zero intersection is calculated or a final sequence position of the second sequence is reached.

5. The method of claim 3, wherein the iteratively comparing terminates for each candidate piece of road structure:
responsive to reaching a final position of either sequence and calculating a non-zero intersection for the final sequence position, resulting in a sequence match, or
responsive to calculating a zero intersection between all three of: a sequence position of the first sequence and a sequence position of the second sequence, a previous sequence position of the first sequence and a next sequence position of the second sequence, and that sequence position of the first sequence and a next sequence position of the second sequence, resulting in a sequence mismatch.

6. The method of claim 5, wherein selecting the target piece of road structure comprises, if the source sequence is determined to match multiple candidate road sequences:
calculating an intersection over union ratio between the source sequence and each matching candidate sequence, and
selecting, as the target piece of road structure, the candidate piece of road structure belonging to the matching candidate sequence for which a greatest intersection over union ratio is calculated.

7. The method of claim 3, wherein each sequence embodies a single traversable path, each piece of road structure in that sequence being a portion of that traversable path.

8. The method of claim 1, wherein the first piece of annotation data comprises:
a first identifier that identifies the source piece of road structure in the first road layout map; and
a first coordinate of the annotation within the source piece of road structure; and
wherein the second piece of annotation data comprises:
a second identifier of the target piece of road structure in the second road layout map; and
a second coordinate of the annotation within the target piece of road structure, the second coordinate determined based on the target piece of road structure.

9. The method of claim 8, wherein the first coordinate comprises a longitudinal or lateral coordinate within the first road layout map, and wherein the second coordinate comprises a longitudinal or lateral coordinate within the second road layout map.

10. The method of claim 1, wherein the first and second pieces of annotation data comprise agent control data configured to control a behaviour of an agent in a simulated environment.

11. The method of claim 10, comprising testing a robotic planner by generating a simulated environment based on the second road layout map, in which an ego agent is controlled by the robotic planner under testing, and another dynamic agent responds to the agent control data.

12. A computer system comprising one or more computers programmed or otherwise configured to implement a method comprising:
identifying in a first road layout map a source piece of road structure associated with a first piece of annotation data;
matching the source piece of road structure with a target piece of road structure exhibited in a second road layout map; and
generating, using the first piece of annotation data, a second piece of annotation data for annotating the target piece of road structure exhibited in the second road layout map.

13. The computer system of claim 12, wherein the one or more computers programmed or otherwise configured to implement a simulator configured to run a test scenario on the second road layout map, the test scenario comprising an ego agent controlled by a robotic planner under testing and at least one other dynamic agent navigating the second road layout map.

14. A computer program product configured to program a computer system so as to carry out a method comprising:
identifying in a first road layout map a source piece of road structure associated with a first piece of annotation data;
matching the source piece of road structure with a target piece of road structure exhibited in a second road layout map; and
generating, using the first piece of annotation data, a second piece of annotation data for annotating the target piece of road structure exhibited in the second road layout map.
